(19) United States
(12) Patent Application Publication
(10) Pub. No.: US 2025/0373870 A1
(43) Pub. Date: Dec. 4, 2025

(54) SYSTEM, METHOD AND COMPUTER-READABLE MEDIUM

(71) Applicant: 17LIVE Japan INC., Tokyo (JP)

(72) Inventors: Uday Kumar EDUDULA, Tokyo (JP); Ajay Prakash MANAGALE, Tokyo (JP); Jayneel PAWAR, Tokyo (JP); Hemant MEHTA, Tokyo (JP); Yen-Hsuan LEE, Taipei City (TW); Yun-Chieh WANG, Taipei City (TW); Shih-Bo LIN, Taipei City (TW)

(21) Appl. No.: 19/222,839

(22) Filed: May 29, 2025

(30) Foreign Application Priority Data
May 30, 2024 (JP) 2024-088331
Jun. 27, 2024 (JP) 2024-104485
Aug. 5, 2024 (JP) 2024-129242

(51) Int. Cl. H04N 21/24; H04N 21/2187; H04N 21/266

(52) U.S. Cl. CPC H04N 21/2407; H04N 21/2187; H04N 21/266

(57) ABSTRACT

The present disclosure relates to a system and a method for recommendation. The method includes: detecting a change of an interaction parameter in a live stream; determining the change to have met a predetermined criterion; and recommending the live stream to a user within a time period of the determining the change to have met the predetermined criterion.

### CROSS-REFERENCE TO RELATED APPLICATIONS

This application is based on and claims the benefit of priority from Japanese Patent Application Serial No. 2024-088331 (filed on May 30, 2024), No. 2024-104485 (filed on Jun. 27, 2024) and No. 2024-129242 (filed on Aug. 5, 2024), the contents of which are hereby incorporated by reference in their entirety.

### BACKGROUND OF THE DISCLOSURE

### Technical Field

The present disclosure relates to stream recommendation and, more particularly, to live stream recommendation.

The present disclosure also relates to streaming and, more particularly, to live streaming.

### Description of Related Art

Real time interaction on the Internet, such as live streaming service, has become popular in our daily life. There are various platforms or providers providing the service of live streaming, and the competition is fierce. It is important for a platform to provide its users their desired services.

Japanese patent application publication JP2019-164617A discloses a system for recommending live videos to users.

Japanese patent application publication JP2019144311 discloses a system for helping a streamer to reply to viewers' comments.

US patent application publication US20230353653A1 discloses a system for notification.

### SUMMARY OF THE INVENTION

A method according to one embodiment of the present disclosure is a method for recommendation being executed by one or a plurality of computers, and includes: detecting a change of an interaction parameter in a live stream; determining the change to have met a predetermined criterion; and recommending the live stream to a user within a time period of the determining the change to have met the predetermined criterion.

A system according to one embodiment of the present disclosure is a system for recommendation that includes one or a plurality of processors, and the one or plurality of computer processors execute a machine-readable instruction to perform: detecting a change of an interaction parameter in a live stream; determining the change to have met a predetermined criterion; and recommending the live stream to a user within a time period of the determining the change to have met the predetermined criterion.

A non-transitory computer-readable medium including a program for recommendation, wherein the program causes one or a plurality of computers to execute: detecting a change of an interaction parameter in a live stream; determining the change to have met a predetermined criterion; and recommending the live stream to a user within a time period of the determining the change to have met the predetermined criterion.

A method according to one embodiment of the present disclosure is a method for live streaming being executed by one or a plurality of computers, and includes: obtaining a comment from a viewer in a live stream room; displaying a selection user interface to the viewer; obtaining a selection result from the viewer through the selection user interface; and expressing the comment in the live stream room according to the selection result.

A system according to one embodiment of the present disclosure is a system for live streaming that includes one or a plurality of processors, and the one or plurality of computer processors execute a machine-readable instruction to perform: obtaining a comment from a viewer in a live stream room; displaying a selection user interface to the viewer; obtaining a selection result from the viewer through the selection user interface; and expressing the comment in the live stream room according to the selection result.

A non-transitory computer-readable medium including a program for live streaming, wherein the program causes one or a plurality of computers to execute: obtaining a comment from a viewer in a live stream room; displaying a selection user interface to the viewer; obtaining a selection result from the viewer through the selection user interface; and expressing the comment in the live stream room according to the selection result.

A method according to one embodiment of the present disclosure is a method for notification being executed by one or a plurality of computers, and includes: transmitting a first notification to a first viewer in accordance with a first condition, the first notification being related to a stream; and transmitting a second notification to a second viewer in accordance with a second condition, the second notification being related to the stream, wherein the first condition is different from the second condition.

A system according to one embodiment of the present disclosure is a system for notification that includes one or a plurality of processors, and the one or plurality of processors execute a machine-readable instruction to perform: transmitting a first notification to a first viewer in accordance with a first condition, the first notification being related to a stream; and transmitting a second notification to a second viewer in accordance with a second condition, the second notification being related to the stream, wherein the first condition is different from the second condition.

A non-transitory computer-readable medium including a program for notification, wherein the program causes one or a plurality of computers to execute: transmitting a first notification to a first viewer in accordance with a first condition, the first notification being related to a stream; and transmitting a second notification to a second viewer in accordance with a second condition, the second notification being related to the stream, wherein the first condition is different from the second condition.

### BRIEF DESCRIPTION OF THE DRAWINGS

FIG. 1 shows a schematic configuration of a live streaming system 1 according to some embodiments of the present disclosure.

FIG. 2 is a block diagram showing functions and configuration of the user terminal 30 of FIG. 1 according to some embodiments of the present disclosure.

FIG. 3 shows a block diagram illustrating functions and configuration of the server 10 of FIG. 1 according to some embodiments of the present disclosure.

FIG. 4 is a data structure diagram of an example of the stream DB 310 of FIG. 3.

FIG. 5 is a data structure diagram showing an example of the user DB 312 of FIG. 3.

FIG. 6 is a data structure diagram showing an example of the gift DB 314 of FIG. 3.

FIG. 7 is a data structure diagram showing an example of the stream parameter DB 330.

FIG. 8 is a data structure diagram showing another example of the stream parameter DB 330.

FIG. 9 is a data structure diagram showing another example of the stream parameter DB 330.

FIG. 10 is a data structure diagram showing an example of the viewer behavior DB 332.

FIG. 11 shows an exemplary flow according to some embodiments of the present disclosure.

FIG. 12 shows an exemplary user interface according to some embodiments of the present disclosure.

FIG. 13 shows an exemplary user interface according to some embodiments of the present disclosure.

FIG. 14 shows an example of stream recommendation according to some embodiments of the present disclosure.

FIG. 15 shows an exemplary user interface according to some embodiments of the present disclosure.

FIG. 16 shows an exemplary user interface according to some embodiments of the present disclosure.

FIG. 17 shows an exemplary flow according to some embodiments of the present disclosure.

FIG. 18 shows an exemplary user interface according to some embodiments of the present disclosure.

FIG. 19 is a block diagram showing an example of a hardware configuration of the information processing device according to some embodiments of the present disclosure.

FIG. 20 shows a block diagram illustrating functions and configuration of the server 10 of FIG. 1 according to some embodiments of the present disclosure.

FIG. 21 is a data structure diagram showing an example of the comment format DB 330a.

FIG. 22 is a data structure diagram showing an example of the comment content DB 332a.

FIG. 23 shows an exemplary flow according to some embodiments of the present disclosure.

FIG. 24 shows an exemplary flow according to some embodiments of the present disclosure.

FIG. 25 shows an example of a live stream room according to some embodiments of the present disclosure.

FIG. 26 shows an example of a live stream room according to some embodiments of the present disclosure.

FIG. 27 shows an example of a live stream room according to some embodiments of the present disclosure.

FIG. 28 shows an example of the format selection UI according to some embodiments of the present disclosure.

FIG. 29 shows a block diagram illustrating functions and configuration of the server 10 of FIG. 1 according to some embodiments of the present disclosure.

FIG. 30 is a data structure diagram showing an example of the PN DB 330b.

FIG. 31 is a data structure diagram showing an example of the PN DB 330b.

FIG. 32 is a data structure diagram showing an example of the PN DB 330b.

FIG. 33 is a data structure diagram showing an example of the PN strategy DB 332b.

FIG. 34 is a data structure diagram showing an example of the PN strategy DB 332b.

FIG. 35 is a data structure diagram showing an example of the PN strategy DB 332b.

FIG. 36 shows an exemplary flow according to some embodiments of the present disclosure.

FIG. 37 is a data structure diagram showing an example of the PN strategy DB 332b.

FIG. 38 is a data structure diagram showing an example of the PN DB 330b.

FIG. 39 shows an exemplary notification according to some embodiments of the present disclosure.

FIG. 40 shows exemplary notifications according to some embodiments of the present disclosure.

### DETAILED DESCRIPTION

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

A streaming platform would like to keep its viewers as engaged as possible, especially when the viewers just enter the platform, to improve the retention rate of the viewers. Therefore, it is desirable for a platform to be able to recommend the right content to the right viewer at the right timing. Or, it is desirable for a platform to be able to invite the right viewer to the right stream room at the right timing.

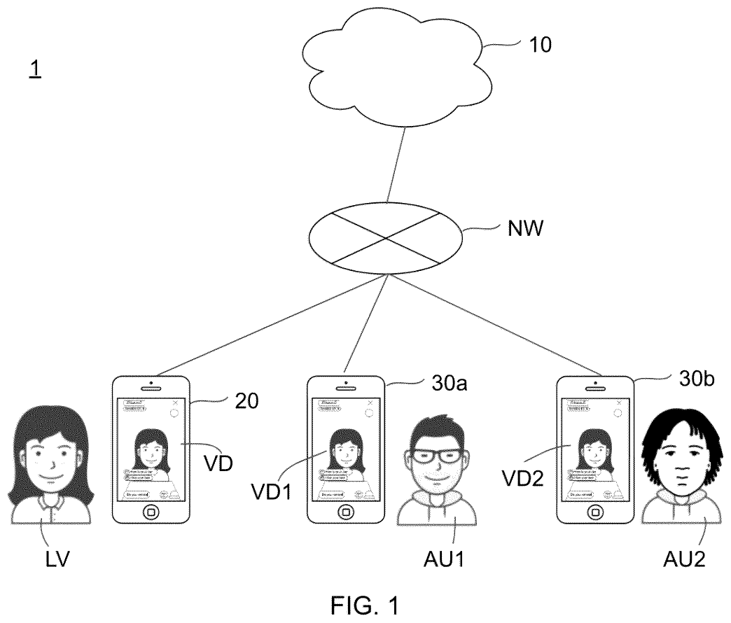

FIG. 1 shows a schematic configuration of a live streaming system 1 according to some embodiments of the present disclosure. The live streaming system 1 provides a live streaming service for the streaming streamer (could be referred to as liver, anchor, distributor, or livestreamer) LV and viewer (could be referred to as audience) AU (AU1, AU2 . . . ) to interact or communicate in real time. As shown in FIG. 1, the live streaming system 1 includes a server 10, a user terminal 20 and user terminals 30 (30a, 30b . . . ). In some embodiments, the streamers and viewers may be collectively referred to as users. The server 10 may include one or a plurality of information processing devices connected to a network NW. The user terminal 20 and 30 may be, for example, mobile terminal devices such as smartphones, tablets, laptop PCs, recorders, portable gaming devices, and wearable devices, or may be stationary devices such as desktop PCs. The server 10, the user terminal 20 and the user terminal 30 are interconnected so as to be able to communicate with each other over the various wired or wireless networks NW.

The live streaming system 1 involves the distributor LV, the viewers AU, and an administrator (or an APP provider, not shown) who manages the server 10. The distributor LV is a person who broadcasts contents in real time by recording the contents with his/her user terminal 20 and uploading them directly or indirectly to the server 10. Examples of the contents may include the distributor's own songs, talks, performances, gameplays, and any other contents. The administrator provides a platform for live-streaming contents on the server 10, and also mediates or manages real-time interactions between the distributor LV and the viewers AU. The viewer AU accesses the platform at his/her user terminal 30 to select and view a desired content. During live-streaming of the selected content, the viewer AU performs operations to comment, cheer, or send gifts via the user terminal 30. The distributor LV who is delivering the content may respond to such comments, cheers, or gifts. The response is transmitted to the viewer AU via video and/or audio, thereby establishing an interactive communication.

The term “live-streaming” may mean a mode of data transmission that allows a content recorded at the user terminal 20 of the distributor LV to be played or viewed at the user terminals 30 of the viewers AU substantially in real time, or it may mean a live broadcast realized by such a mode of transmission. The live-streaming may be achieved using existing live delivery technologies such as HTTP Live Streaming, Common Media Application Format, Web Real-Time Communications, Real-Time Messaging Protocol and MPEG DASH. Live-streaming includes a transmission mode in which the viewers AU can view a content with a specified delay simultaneously with the recording of the content by the distributor LV. As for the length of the delay, it may be acceptable for a delay with which interaction between the distributor LV and the viewers AU can be established. Note that the live-streaming is distinguished from so-called on-demand type transmission, in which the entire recorded data of the content is once stored on the server, and the server provides the data to a user at any subsequent time upon request from the user.

The term “video data” herein refers to data that includes image data (also referred to as moving image data) generated using an image capturing function of the user terminals 20 or 30, and audio data generated using an audio input function of the user terminals 20 or 30. Video data is reproduced in the user terminals 20 and 30, so that the users can view contents. In some embodiments, it is assumed that between video data generation at the distributor's user terminal and video data reproduction at the viewer's user terminal, processing is performed onto the video data to change its format, size, or specifications of the data, such as compression, decompression, encoding, decoding, or transcoding. However, the content (e.g., video images and audios) represented by the video data before and after such processing does not substantially change, so that the video data after such processing is herein described as the same as the video data before such processing. In other words, when video data is generated at the distributor's user terminal and then played back at the viewer's user terminal via the server 10, the video data generated at the distributor's user terminal, the video data that passes through the server 10, and the video data received and reproduced at the viewer's user terminal are all the same video data.

In the example in FIG. 1, the distributor LV provides the live streaming data. The user terminal 20 of the distributor LV generates the streaming data by recording images and sounds of the distributor LV, and the generated data is transmitted to the server 10 over the network NW. At the same time, the user terminal 20 displays a recorded video image VD of the distributor LV on the display of the user terminal 20 to allow the distributor LV to check the live streaming contents currently performed.

The user terminals 30a and 30b of the viewers AU1 and AU2 respectively, who have requested the platform to view the live streaming of the distributor LV, receive video data related to the live streaming (may also be herein referred to as “live-streaming video data”) over the network NW and reproduce the received video data to display video images VD1 and VD2 on the displays and output audio through the speakers. The video images VD1 and VD2 displayed at the user terminals 30a and 30b, respectively, are substantially the same as the video image VD captured by the user terminal 20 of the distributor LV, and the audio outputted at the user terminals 30a and 30b is substantially the same as the audio recorded by the user terminal 20 of the distributor LV.

Recording of the images and sounds at the user terminal 20 of the distributor LV and reproduction of the video data at the user terminals 30a and 30b of the viewers AU1 and AU2 are performed substantially simultaneously. Once the viewer AU1 types a comment about the contents provided by the distributor LV on the user terminal 30a, the server 10 displays the comment on the user terminal 20 of the distributor LV in real time and also displays the comment on the user terminals 30a and 30b of the viewers AU1 and AU2, respectively. When the distributor LV reads the comment and develops his/her talk to cover and respond to the comment, the video and sound of the talk are displayed on the user terminals 30a and 30b of the viewers AU1 and AU2, respectively. This interactive action is recognized as the establishment of a conversation between the distributor LV and the viewer AU1. In this way, the live streaming system 1 realizes the live streaming that enables interactive communication, not one-way communication.

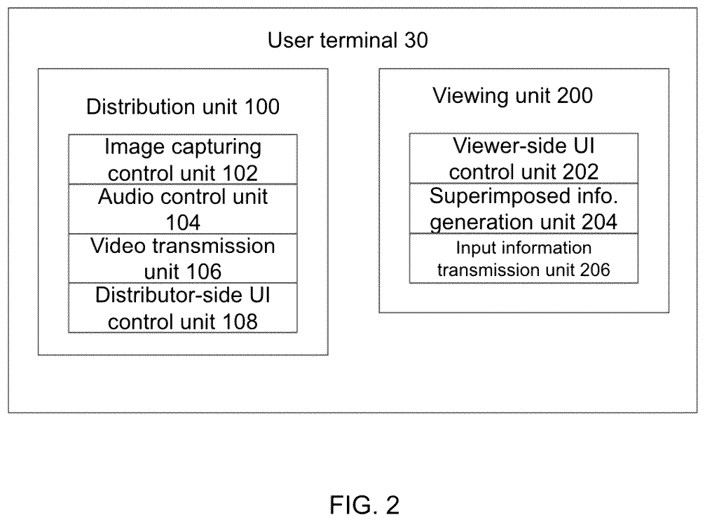

FIG. 2 is a block diagram showing functions and configuration of the user terminal 30 of FIG. 1 according to some embodiments of the present disclosure. The user terminal 20 has the same or similar functions and configuration as the user terminal 30. Each block in FIG. 2 and the subsequent block diagrams may be realized by elements such as a computer CPU or a mechanical device in terms of hardware, and can be realized by a computer program or the like in terms of software. Functional blocks could be realized by cooperative operation between these elements. Therefore, it is understood by those skilled in the art that these functional blocks can be realized in various forms by combining hardware and software.

The distributor LV and the viewers AU may download and install a live streaming application program (hereinafter referred to as a live streaming application) to the user terminals 20 and 30 from a download site over the network NW. Alternatively, the live streaming application may be pre-installed on the user terminals 20 and 30. When the live streaming application is executed on the user terminals 20 and 30, the user terminals 20 and 30 communicate with the server 10 over the network NW to implement or execute various functions. Hereinafter, the functions implemented by the user terminals 20 and 30 (processors such as CPUs) in which the live streaming application is run will be described as functions of the user terminals 20 and 30. These functions are realized in practice by the live streaming application on the user terminals 20 and 30. In some embodiments, these functions may be realized by a computer program that is written in a programming language such as HTML (HyperText Markup Language), transmitted from the server 10 to web browsers of the user terminals 20 and 30 over the network NW, and executed by the web browsers.

The user terminal 30 includes a distribution unit 100 and a viewing unit 200. The distribution unit 100 generates video data in which the user's (or the user side's) image and sound are recorded, and provides the video data to the server 10. The viewing unit 200 receives video data from the server 10 to reproduce the video data. The user activates the distribution unit 100 when the user performs live streaming, and activates the viewing unit 200 when the user views a video. The user terminal in which the distribution unit 100 is activated is the distributor's terminal, i.e., the user terminal that generates the video data. The user terminal in which the viewing unit 200 is activated is the viewer's terminal, i.e., the user terminal in which the video data is reproduced and played.

The distribution unit 100 includes an image capturing control unit 102, an audio control unit 104, a video transmission unit 106, and a distribution-side UI control unit 108. The image capturing control unit 102 is connected to a camera (not shown in FIG. 2) and controls image capturing performed by the camera. The image capturing control unit 102 obtains image data from the camera. The audio control unit 104 is connected to a microphone (not shown in FIG. 2) and controls audio input from the microphone. The audio control unit 104 obtains audio data through the microphone. The video transmission unit 106 transmits video data including the image data obtained by the image capturing control unit 102 and the audio data obtained by the audio control unit 104 to the server 10 over the network NW. The video data is transmitted by the video transmission unit 106 in real time. That is, the generation of the video data by the image capturing control unit 102 and the audio control unit 104, and the transmission of the generated video data by the video transmission unit 106 are performed substantially at the same time. The distribution-side UI control unit 108 controls an UI (user interface) for the distributor. The distribution-side UI control unit 108 may be connected to a display (not shown in FIG. 2), and displays a video on the display by reproducing the video data that is to be transmitted by the video transmission unit 106. The distribution-side UI control unit 108 may display an operation object or an instruction-accepting object on the display, and accepts inputs from the distributor who taps on the object.

The viewing unit 200 includes a viewer-side UI control unit 202, a superimposed information generation unit 204, and an input information transmission unit 206. The viewing unit 200 receives, from the server 10 over the network NW, video data related to the live streaming in which the distributor, the viewer who is the user of the user terminal 30, and other viewers participate. The viewer-side UI control unit 202 controls the UI for the viewers. The viewer-side UI control unit 202 is connected to a display and a speaker (not shown in FIG. 2), and reproduces the received video data to display video images on the display and output audio through the speaker. The state where the image is outputted to the display and the audio is outputted from the speaker can be referred to as “the video data is played”. The viewer-side UI control unit 202 is also connected to input means (not shown in FIG. 2) such as touch panels, keyboards, and displays, and obtains user input via these input means. The superimposed information generation unit 204 superimposes a predetermined frame image on an image generated from the video data from the server 10. The frame image includes various user interface objects (hereinafter simply referred to as “objects”) for accepting inputs from the user, comments entered by the viewers, and/or information obtained from the server 10. The input information transmission unit 206 transmits the user input obtained by the viewer-side UI control unit 202 to the server 10 over the network NW.

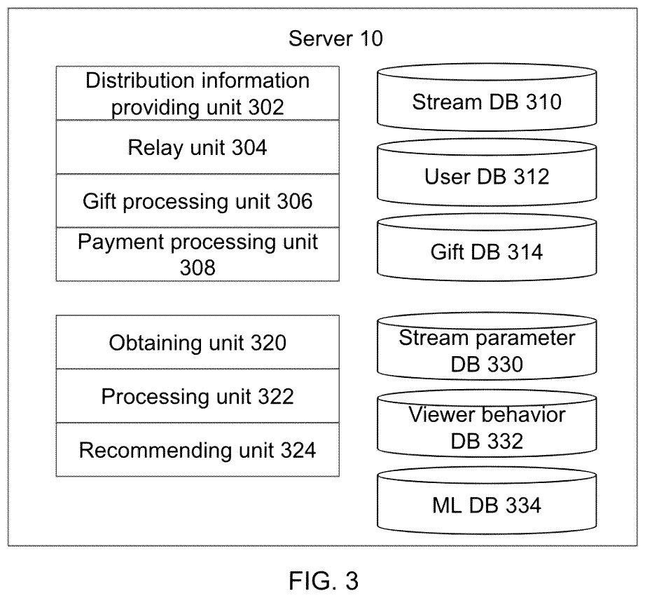

FIG. 3 shows a block diagram illustrating functions and configuration of the server 10 of FIG. 1 according to some embodiments of the present disclosure. The server 10 includes a distribution information providing unit 302, a relay unit 304, a gift processing unit 306, a payment processing unit 308, a stream DB 310, a user DB 312, a gift DB 314, an obtaining unit 320, a processing unit 322, a recommending unit 324, a stream parameter DB 330, a viewer behavior DB 332, and a ML DB 334.

Upon reception of a notification or a request from the user terminal 20 on the distributor side to start a live streaming over the network NW, the distribution information providing unit 302 registers a stream ID for identifying this live streaming and the distributor ID of the distributor who performs the live streaming in the stream DB 310.

When the distribution information providing unit 302 receives a request to provide information about live streams from the viewing unit 200 of the user terminal 30 on the viewer side over the network NW, the distribution information providing unit 302 retrieves or checks currently available live streams from the stream DB 310 and makes a list of the available live streams. The distribution information providing unit 302 transmits the generated list to the requesting user terminal 30 over the network NW. The viewer-side UI control unit 202 of the requesting user terminal 30 generates a live stream selection screen based on the received list and displays it on the display of the user terminal 30.

Once the input information transmission unit 206 of the user terminal 30 receives the viewer's selection result on the live stream selection screen, the input information transmission unit 206 generates a distribution request including the stream ID of the selected live stream, and transmits the request to the server 10 over the network NW. The distribution information providing unit 302 starts providing, to the requesting user terminal 30, the live stream specified by the stream ID included in the received distribution request. The distribution information providing unit 302 updates the stream DB 310 to include the user ID of the viewer of the requesting user terminal 30 into the viewer IDs of (or corresponding to) the stream ID.

The relay unit 304 relays the video data from the distributor-side user terminal 20 to the viewer-side user terminal 30 in the live streaming started by the distribution information providing unit 302. The relay unit 304 receives from the input information transmission unit 206 a signal that represents user input by a viewer during the live streaming or reproduction of the video data. The signal that represents user input may be an object specifying signal for specifying an object displayed on the display of the user terminal 30. The object specifying signal may include the viewer ID of the viewer, the distributor ID of the distributor of the live stream that the viewer watches, and an object ID that identifies the object. When the object is a gift, the object ID is the gift ID. Similarly, the relay unit 304 receives, from the distribution unit 100 of the user terminal 20, a signal that represents user input performed by the distributor during reproduction of the video data (or during the live streaming). The signal could be an object specifying signal.

Alternatively, the signal that represents user input may be a comment input signal including a comment entered by a viewer into the user terminal 30 and the viewer ID of the viewer. Upon reception of the comment input signal, the relay unit 304 transmits the comment and the viewer ID included in the signal to the user terminal 20 of the distributor and the user terminals 30 of other viewers. In these user terminals 20 and 30, the viewer-side UI control unit 202 and the superimposed information generation unit 204 display the received comment on the display in association with the viewer ID also received.

The gift processing unit 306 updates the user DB 312 so as to increase the points of the distributor depending on the points of the gift identified by the gift ID included in the object specifying signal. Specifically, the gift processing unit 306 refers to the gift DB 314 to specify the points to be granted for the gift ID included in the received object specifying signal. The gift processing unit 306 then updates the user DB 312 to add the determined points to the points of (or corresponding to) the distributor ID included in the object specifying signal.

The payment processing unit 308 processes payment of a price of a gift from a viewer in response to reception of the object specifying signal. Specifically, the payment processing unit 308 refers to the gift DB 314 to specify the price points of the gift identified by the gift ID included in the object specifying signal. The payment processing unit 308 then updates the user DB 312 to subtract the specified price points from the points of the viewer identified by the viewer ID included in the object specifying signal.

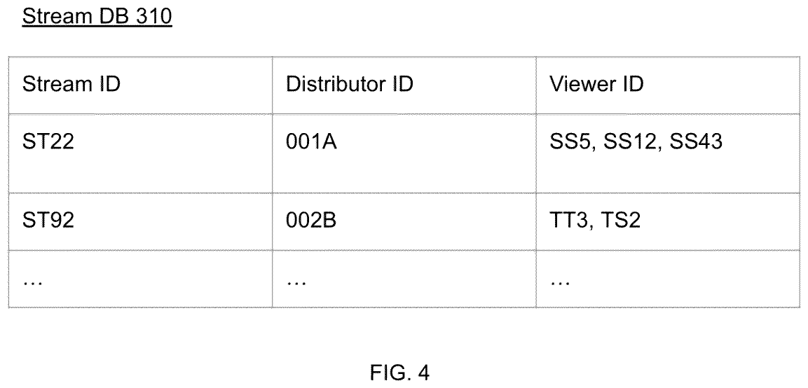

FIG. 4 is a data structure diagram of an example of the stream DB 310 of FIG. 3. The stream DB 310 holds information regarding a live stream currently taking place. The stream DB 310 stores the stream ID, the distributor ID, and the viewer ID, in association with each other. The stream ID is for identifying a live stream on a live streaming platform provided by the live streaming system 1. The distributor ID is a user ID for identifying the distributor who provides the live stream. The viewer ID is a user ID for identifying a viewer of the live stream. In the live streaming platform provided by the live streaming system 1 of some embodiments, when a user starts a live stream, the user becomes a distributor, and when the same user views a live stream broadcast by another user, the user also becomes a viewer. Therefore, the distinction between a distributor and a viewer is not fixed, and a user ID registered as a distributor ID at one time may be registered as a viewer ID at another time.

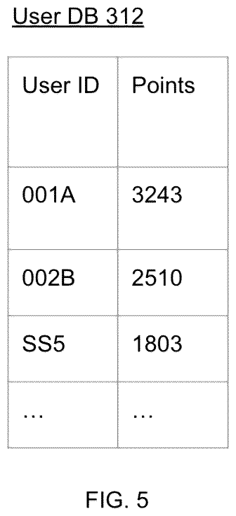

FIG. 5 is a data structure diagram showing an example of the user DB 312 of FIG. 3. The user DB 312 holds information regarding users. The user DB 312 stores the user ID and the point, in association with each other. The user ID identifies a user. The point corresponds to the points the corresponding user holds. The point is the electronic value circulated within the live streaming platform. In some embodiments, when a distributor receives a gift from a viewer during a live stream, the distributor's points increase by the value corresponding to the gift. The points are used, for example, to determine the amount of reward (such as money) the distributor receives from the administrator of the live streaming platform. In some embodiments, when the distributor receives a gift from a viewer, the distributor may be given the amount of money corresponding to the gift instead of the points.

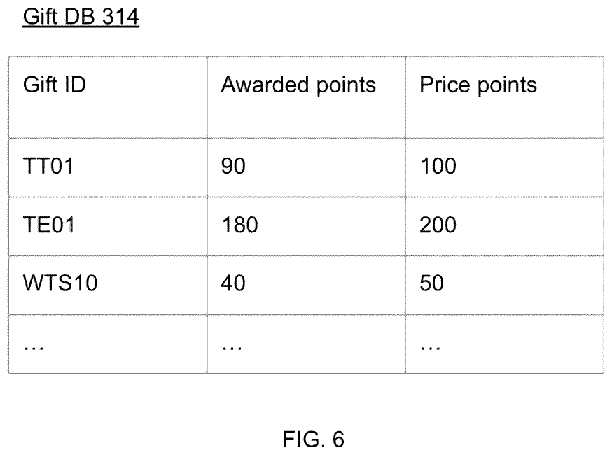

FIG. 6 is a data structure diagram showing an example of the gift DB 314 of FIG. 3. The gift DB 314 holds information regarding gifts available for the viewers in the live streaming. A gift is electronic data. A gift may be purchased with the points or money, or can be given for free. A gift may be given by a viewer to a distributor. Giving a gift to a distributor is also referred to as using, sending, or throwing the gift. Some gifts may be purchased and used at the same time, and some gifts may be purchased and then used at any time later by the purchaser viewer. When a viewer gives a gift to a distributor, the distributor is awarded the amount of points corresponding to the gift. When a gift is used, the use may trigger an effect associated with the gift. For example, an effect (such as visual or sound effect) corresponding to the gift will appear on the live streaming screen.

The gift DB 314 stores the gift ID, the awarded points, and the price points, in association with each other. The gift ID is for identifying a gift. The awarded points are the amount of points awarded to a distributor when the gift is given to the distributor. The price points are the amount of points to be paid for use (or purchase) of the gift. A viewer is able to give a desired gift to a distributor by paying the price points of the desired gift when the viewer is viewing the live stream. The payment of the price points may be made by an appropriate electronic payment means. For example, the payment may be made by the viewer paying the price points to the administrator. Alternatively, bank transfers or credit card payments may be used. The administrator is able to desirably set the relationship between the awarded points and the price points. For example, it may be set as the awarded points=the price points. Alternatively, points obtained by multiplying the awarded points by a predetermined coefficient such as 1.2 may be set as the price points, or points obtained by adding predetermined fee points to the awarded points may be set as the price points.

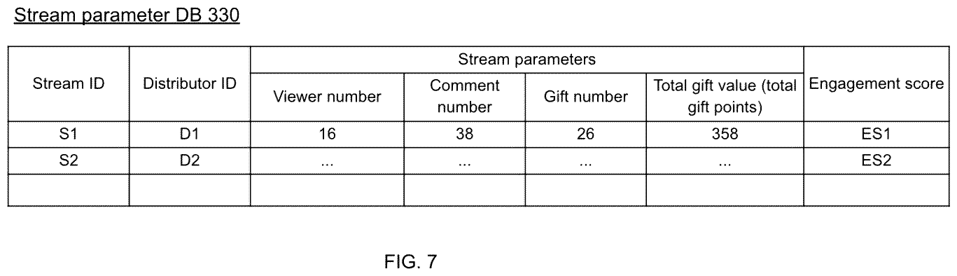

FIG. 7 is a data structure diagram showing an example of the stream parameter DB 330. The stream parameter DB 330 stores the stream ID, the distributor ID, the stream parameters, and the engagement score, in association with each other.

The stream ID identifies a stream room. The distributor ID identifies the distributor of the stream room. The stream parameters include various interaction parameters regarding (or occurring in) the stream room, such as the viewer number, the comment number (number of comments from viewers), a number of emojis in the stream room, the gift number (number of gifts sent from viewers), and/or the total gift value (or total gift points). In some embodiments, the stream parameters may include a change rate of the viewer number, a change rate of the comment number, a change rate of the gift number, and/or a change rate of the total gift value. The change rate could be an increase change rate (or increase rate), for example.

The stream parameters could be obtained or calculated in a real time manner. For example, each parameter may be calculated using its values within a time period (such as 1 mins) from the current timing, to reflect the latest number or the latest change of the parameter.

The engagement score indicates how much the users (such as viewers or distributor) are engaged in the stream. The engagement score is determined according to the stream parameters. For example, the engagement score may be determined to be proportional to one or more stream parameters (or change rate of stream parameters). For example, the engagement score may increase when one or more stream parameters (or change rate of stream parameters) increase. In some embodiments, the engagement score could be a change rate of one stream parameter. A higher engagement score indicates that users in the corresponding stream are more engaged in the stream provided by the distributor. The engagement score could be calculated in a real time manner according to the real time values of the stream parameters.

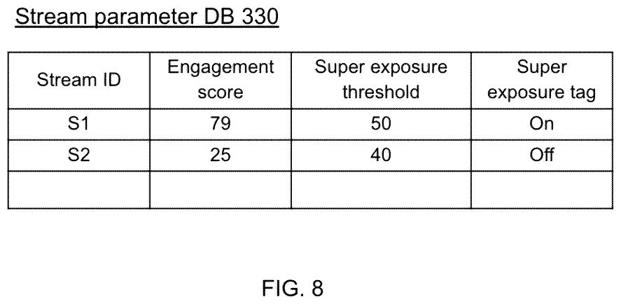

FIG. 8 is a data structure diagram showing another example of the stream parameter DB 330. The stream parameter DB 330 stores the stream ID, the engagement score, the super exposure threshold, and the super exposure tag, in association with each other.

The super exposure threshold is a threshold for the engagement score to determine if the corresponding stream has reached a super exposure mode. If the stream reaches the super exposure mode, the super exposure tag is marked “On”, otherwise the super exposure tag is marked “Off”. The super exposure mode will cause the stream to be recommended to (or to be notified to) viewers in a more aggressive (or more active) manner. Details will be explained later. In some embodiments, thresholds can be different according to distributor level. For example, a higher level distributor may have a higher threshold than that of a lower level distributor. The mechanism can encourage or motivate distributors of all levels (and/or their viewers) to try their best to achieve the super exposure mode.

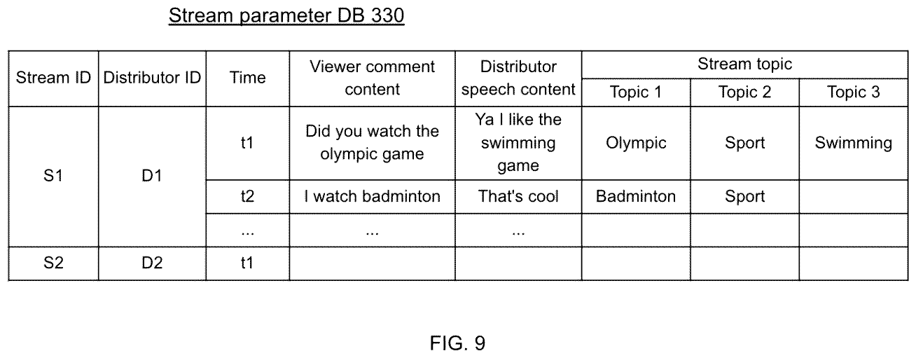

FIG. 9 is a data structure diagram showing another example of the stream parameter DB 330. The stream parameter DB 330 stores the stream ID, the distributor ID, the time (or time span), the viewer comment content, the distributor speech content, and the stream topic, in association with each other.

The viewer comment content stores the contents of comments from various viewers. In some embodiments, the respective viewer ID (or user ID) could also be stored.

The distributor speech content stores the contents of what the distributor said. In some embodiments, speech of the distributor could be transformed into text form by the processing unit 322 by utilizing the ML DB 334. In some embodiments, an additional speech to text (STT) module could be utilized.

The stream topic stores the topic(s) extracted from the viewer comment content and the distributor speech content. In some embodiments, the processing unit 322 may utilize the ML DB 334 to analyze the viewer comment content and the distributor speech content, to deliver one or more topics that are correlated to (or the most similar to) those contents. In some embodiments, topic 1, topic 2 and topic 3 may be ordered according to the correlation score (or the similarity score).

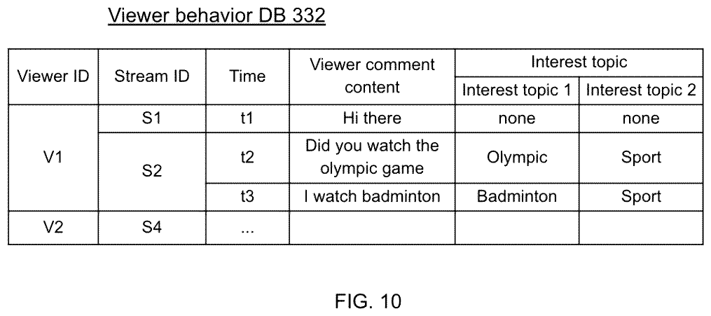

FIG. 10 is a data structure diagram showing an example of the viewer behavior DB 332. The viewer behavior DB 332 stores the viewer ID, the stream ID, the time (or time span), the viewer comment content, and the interest topics, in association with each other.

The interest topic stores the topic(s) determined to be of the viewer's interest. In some embodiments, the processing unit 322 may utilize the ML DB 334 to analyze the viewer comment content, to determine the interest topic(s) (or the real time interest topic) of the viewer. In some embodiments, the viewer behavior DB 332 also stores bio info or tag info input by the viewer on the streaming platform. The bio info or tag info may also be utilized to determine the interest topic of the user.

The ML DB 334 may store various machine learning models or AI models. For example, one or more large language models (LLM) may be included in the ML DB 334. Various kinds of TTS (Text to speech) models could be included. Various topic detection models may also be implemented within the ML DB 334.

In some embodiments, the values/contents in the stream parameter DB 330 and/or the viewer behavior DB 332 could be obtained/stored by the obtaining unit 320. In some embodiments, some values/contents in the stream parameter DB 330 and/or the viewer behavior DB 332 could be calculated/determined by the processing unit 322. In some embodiments, the stream parameter DB 330 could be part of the stream DB 310. In some embodiments, the viewer behavior DB 332 could be part of the user DB 312.

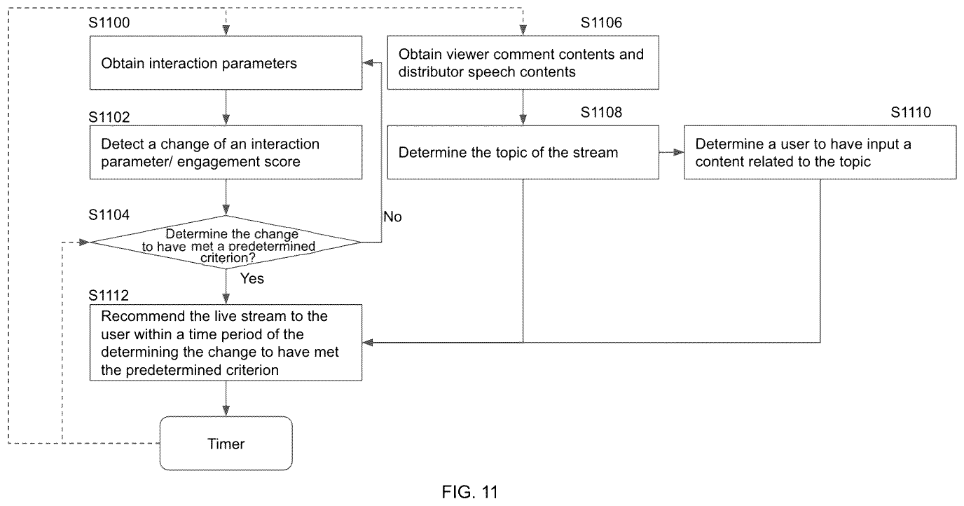

FIG. 11 shows an exemplary flow according to some embodiments of the present disclosure.

At step S1100, the obtaining unit 320 obtains interaction parameters (or stream parameters) of a live stream. In some embodiments, those data could be obtained from a third party monitoring service supporting the streaming platform.

At step S1102, the processing unit 322 detects or calculates a change (or a change rate) of one or more interaction parameters. The processing unit 322 may also calculate the engagement score or a change/change rate of the engagement score, according to the interaction parameters.

At step S1104, the processing unit 322 determines whether or not the change(s)/change rate(s) has met a predetermined criterion. For example, the criterion may require [comment number increase by 30% and total gift value increase by 40%, within 1 min]. If yes, the flow goes to step S1112, if no, the flow goes back to step S1100. In some embodiments, the steps S1100, S1102 and S1104 may be performed for each live stream.

At step S1106, the obtaining unit 320 obtains viewer comment contents and distributor speech contents. The data could be from various stream rooms. In some embodiments, those data could be obtained from a third party monitoring service supporting the streaming platform.

At step S1108, the topic (or real time topic) of the stream room is determined by the processing unit 322. In some embodiments, the stream room here is the stream room wherein the change/change rate of the stream parameters has met the predetermined criterion.

At step S1110, the processing unit 322 determines one or more users to have input contents (such as a comment input by the user in any stream room) related to the topic. In some embodiments, the user may be determined only when he/she inputs the content within a predetermined time span before or after the determination of the stream topic. In some embodiments, the user may input the related content in another live stream room different from the live stream room.

At step S1112, the recommending unit 324 recommends the live stream to the user(s) within a time period of the determining the change to have met the predetermined criterion in step S1104. The recommendation could include sending a notification about the live stream to the user. In some embodiments, the notification could be sent to the user when the user is in another live stream. The flow then goes to a timer for a predetermined time span. In some embodiments, the flow then goes back to step S1104 to monitor if the criterion is still being met. In some embodiments, the flow then goes back to step S1100 and step S1106 for a new cycle.

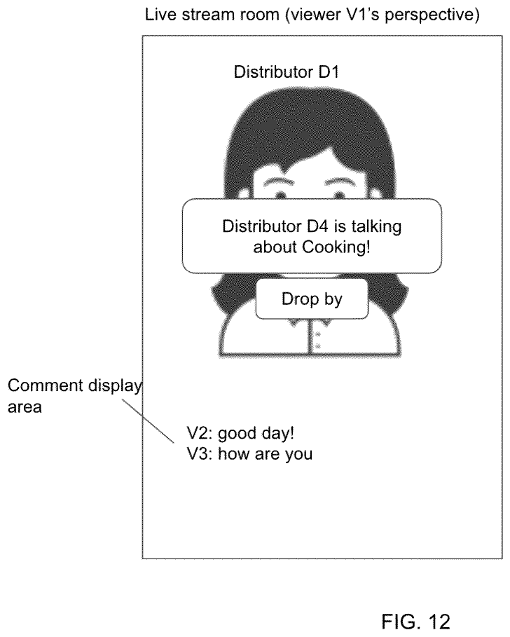

FIG. 12 shows an exemplary user interface according to some embodiments of the present disclosure. The live stream room of distributor D1 is shown, from viewer V1's perspective. While viewer V1 is in distributor D1's stream room, a recommending notification indicating “Distributor D4 is talking about Cooking!” is shown. Viewer V1 can select the “Drop by” button to transfer or jump to the live stream room of distributor D4. The transferring process could be performed by the processing unit 322.

In this example, viewer V1 may have been determined to have input some comments related to the topic “cooking” on the platform (could be in any stream room), and the contents (such as viewer comments and/or distributor's speech) in distributor D4's stream room may have been determined to correspond to the topic “cooking” right before the timing of the recommending notification.

In some embodiments, the recommending notification is only visible to viewer V1, and is not visible to the distributor or other viewers. That is, the recommending notification is customized for viewer V1 based on viewer V1's behavior on the platform. In some embodiments, the recommending notification could be a notification (such as a SMS notification) sent to viewer V1 even when viewer V1 is not on the streaming platform (that is, not in any stream room).

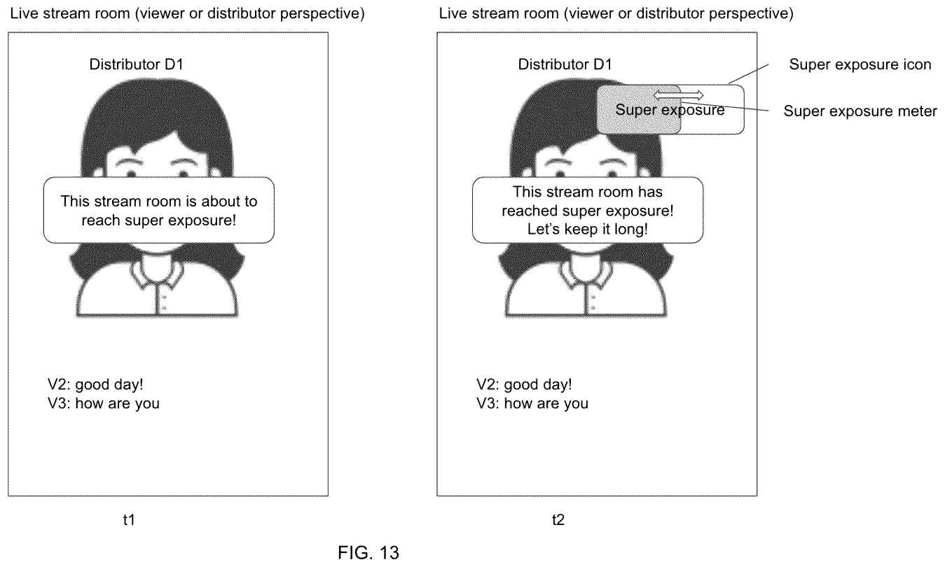

FIG. 13 shows an exemplary user interface according to some embodiments of the present disclosure. The user interface could apply to viewer perspective or distributor perspective.

At timing t1, the engagement score of the stream room is detected (by the processing unit 322, for example) to be close to but not yet reach the super exposure threshold. A notification indicating “This stream room is about to reach super exposure!” is shown to the distributor and all viewers in the stream room. The distributor may encourage viewers to contribute more interaction parameters (such as commenting or gifting) to reach the super exposure mode.

At timing t2, the engagement score of the stream room is detected (by the processing unit 322, for example) to have reached the super exposure threshold. Therefore the super exposure mode is turned on for the stream. A notification indicating “This stream room has reached super exposure! Let's keep it long!” is shown to encourage the distributor and/or the viewers to help maintain the interaction momentum in the stream room. A super exposure icon is shown when the stream enters the super exposure mode. The icon may include a meter indicating the real time variation of the engagement score, to improve the viewers' motivation to keep it high. In some embodiments, when the meter drops below the super exposure threshold the super exposure mode will be turned off.

When a stream room is in the super exposure mode, recommending notifications about the stream room (which could include the topic of the stream room) are being sent to (or will be sent to) users in a more aggressive (or more active) manner. The recommending notifications could be sent to users who have expressed interest in the topic (such as inputting comments about the topic) lately on the platform. The users may not be followers of the distributor of the stream room. The recommending notifications could be sent to users when they are in the middle of viewing another stream room. The recommending notifications could be sent to the users when they are not on the streaming platform, in the form of SMS notification, for example.

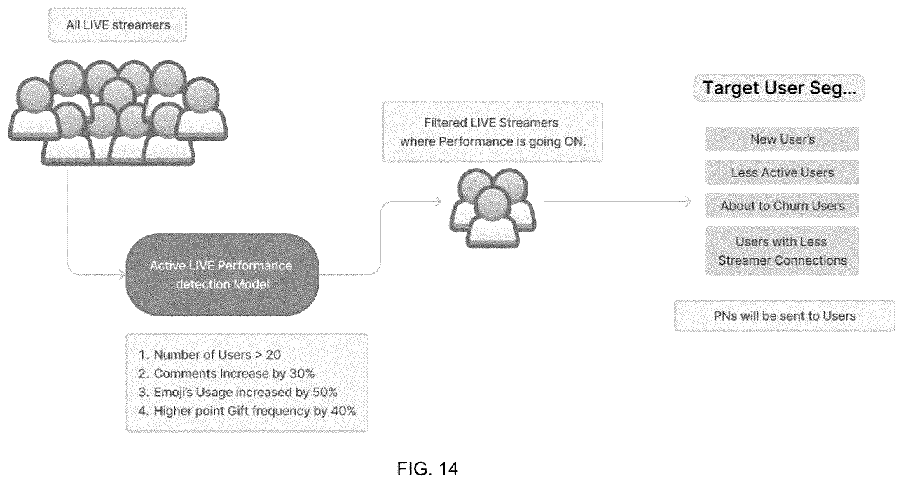

FIG. 14 shows an example of stream recommendation according to some embodiments of the present disclosure. The active live performance detection model could correspond to the server 10, the obtaining unit 320, and/or the processing unit 322. The change (or change rate) of the number of users, the comment number, the emoji number, and/or the high point gift frequency are monitored and are compared with their respective thresholds. The filtered live streamers are the streamers (or distributors) of the stream rooms wherein the stream parameters meet respective thresholds. The recommending unit 324 then recommends (or notifies) the filtered streams to target users. The target users could be new users, less active users, users about to churn, or users with less streamer connections.

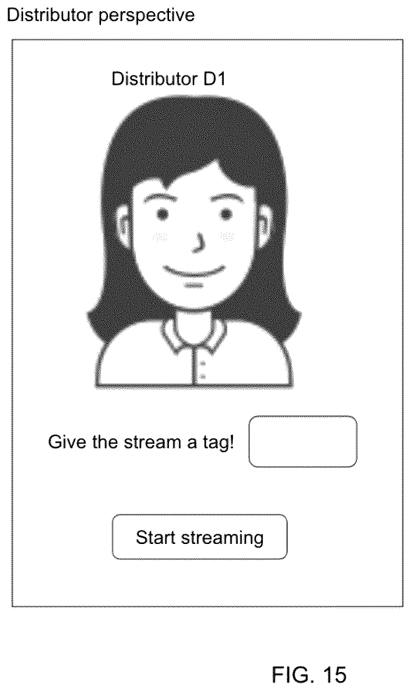

FIG. 15 shows an exemplary user interface according to some embodiments of the present disclosure. The user interface could apply to the distributor perspective. Before the distributor starts the live stream, he/she can choose or enter a tag for the stream.

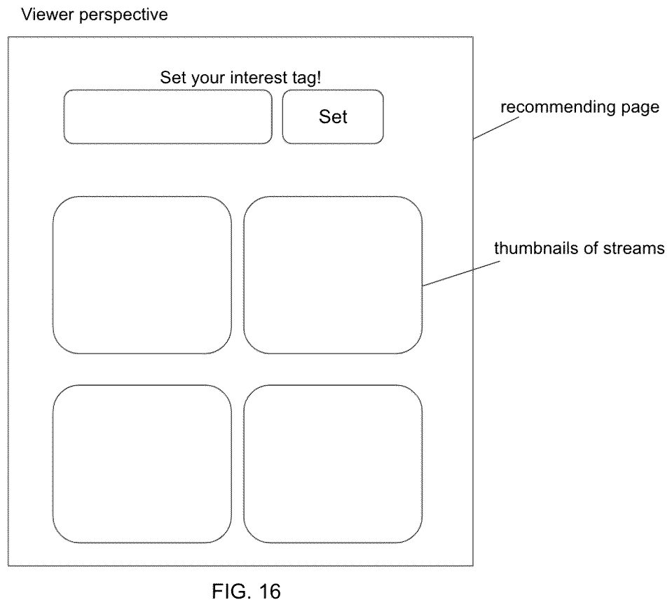

FIG. 16 shows an exemplary user interface according to some embodiments of the present disclosure. The user interface could apply to the viewer perspective. Before the viewer enters a live stream, he/she can choose or enter a tag representing his/her interest.

The system (such as server 10 or the processing unit 322) may then monitor tags of all current or newly launched streams. The system may send a notification to the viewer when a stream's tag is found to be related to the viewer's interest tag. A similarity matching process could be performed by the processing unit 322. The notification may indicate “the distributor D4 starts the stream with the tag “sport” which matches your interest tag”.

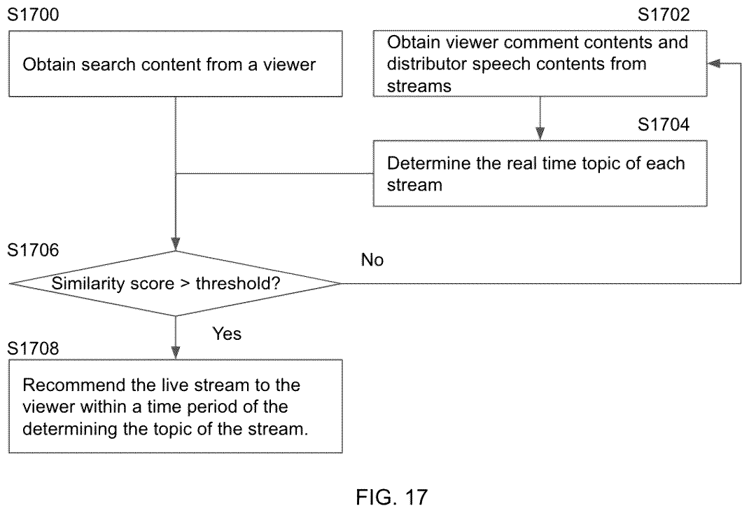

FIG. 17 shows an exemplary flow according to some embodiments of the present disclosure.

At step S1700, the obtaining unit 320 obtains a search content from a viewer. The viewer may enter the search content in a search user interface on the streaming platform.

At step S1702, the obtaining unit 320 obtains (or extracts) viewer comment contents and distributor speech contents from available live streams. The obtaining processes could be performed in a real time manner or a continuous manner.

At step S1704, the processing unit 322 determines the real time topic of each stream.

At step S1706, the processing unit 322 calculates the similarity score (or correlation score, or matching score) between the search content and the topic of each stream. The processing unit 322 compares the similarity score of each stream with a threshold. If there is one or more streams whose similarity score is higher than the threshold, the flow goes to step S1708. If the similarity scores of all streams are lower than the threshold, the flow goes back to step S1702. In some embodiments, if the similarity scores of all streams are lower than the threshold, a notification indicating “your search content is not being discussed in any available stream right now” is displayed to the viewer.

At step S1708, the recommending unit 324 recommends the live streams whose similarity scores are higher than the threshold to the viewer, within a time period of determining the topics of the live streams.

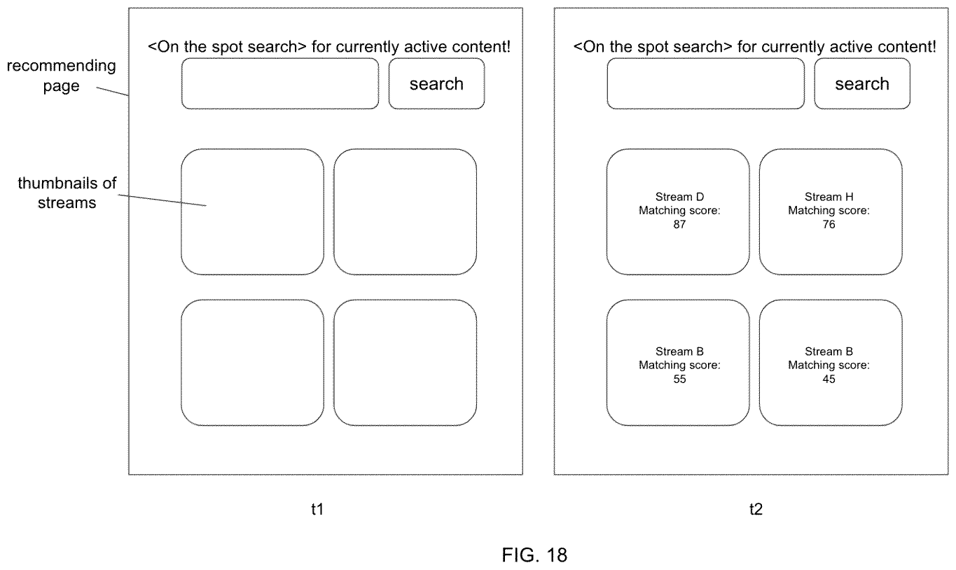

FIG. 18 shows an exemplary user interface according to some embodiments of the present disclosure. The user interface could apply to the viewer perspective on a streaming platform.

At timing t1, the viewer is able to enter a search content, to search for “on the spot” or “currently active” topics in live streams. At timing t2, live streams with higher matching scores are shown on the recommending page. The viewer can then select a stream to enjoy the ongoing topic which is currently being discussed by the viewers and/or the distributor in the stream room.

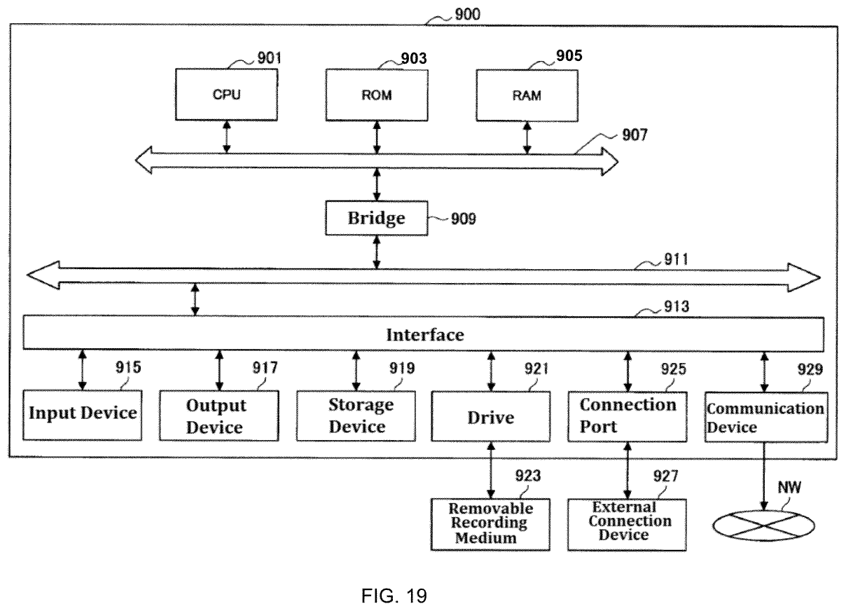

Referring to FIG. 19, the hardware configuration of the information processing device will be now described. FIG. 19 is a block diagram showing an example of a hardware configuration of the information processing device according to some embodiments of the present disclosure. The illustrated information processing device 900 may, for example, realize the server 10 and/or the user terminals 20 and 30 in some embodiments.

The information processing device 900 includes a CPU 901, ROM (Read Only Memory) 903, and RAM (Random Access Memory) 905. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). In addition to or instead of the CPU 901, the information processing device 900 may also include a DSP (Digital Signal Processor) or ASIC (Application Specific Integrated Circuit).

The CPU 901 functions as an arithmetic processing device and a control device, and controls all or some of the operations in the information processing device 900 according to various programs stored in the ROM 903, the RAM 905, the storage device 919, or the removable recording medium 923. For example, the CPU 901 controls the overall operation of each functional unit included in the server 10 and the user terminals 20 and 30 in some embodiments. The ROM 903 stores programs, calculation parameters, and the like used by the CPU 901. The RAM 905 serves as a primary storage that stores a program used in the execution of the CPU 901, parameters that appropriately change in the execution, and the like. The CPU 901, ROM 903, and RAM 905 are interconnected to each other by a host bus 907 which may be an internal bus such as a CPU bus. Further, the host bus 907 is connected to an external bus 911 such as a PCI (Peripheral Component Interconnect/Interface) bus via a bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and instructs operations to the information processing device 900.

The output device 917 is a device capable of visually or audibly informing the user of the obtained information. The output device 917 may be, for example, a display such as an LCD, PDP, or OLED, etc., a sound output device such as a speaker and headphones, and a printer. The output device 917 outputs the results of processing by the information processing device 900 as text, video such as images, or sound such as audio.

The storage device 919 is a device for storing data configured as an example of a storage unit of the information processing device 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for a removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 905. Further, the drive 921 writes records in the attached removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network NW. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP/IP. The communication network NW connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is an imaging element such as a CCD (Charge Coupled Device) or CMOS (Complementary Metal Oxide Semiconductor), and a device that captures an image of the real space using various elements such as lenses for controlling image formation of a subject on the imaging element to generate the captured image. The image capturing device may capture a still image or may capture a moving image.

The configuration and operation of the live streaming system 1 in the embodiment have been described. This embodiment is a mere example, and it is understood by those skilled in the art that various modifications are possible for each component and a combination of each process, and that such modifications are also within the scope of the present disclosure.

The processing and procedures described in the present disclosure may be realized by software, hardware, or any combination of these in addition to what was explicitly described. For example, the processing and procedures described in the specification may be realized by implementing a logic corresponding to the processing and procedures in a medium such as an integrated circuit, a volatile memory, a non-volatile memory, a non-transitory computer-readable medium and a magnetic disk. Further, the processing and procedures described in the specification can be implemented as a computer program corresponding to the processing and procedures, and can be executed by various kinds of computers.

Furthermore, the system or method described in the above embodiments may be integrated into programs stored in a computer-readable non-transitory medium such as a solid state memory device, an optical disk storage device, or a magnetic disk storage device. Alternatively, the programs may be downloaded from a server via the Internet and be executed by processors.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed, but includes another variation and modification that do not disobey the present disclosure, and is the scope covered by the patent application scope.

Commenting on a streaming platform is an important feature that allows a viewer to communicate with the streamer. Therefore, it is desirable for a platform to be able to provide a flexible commenting feature.

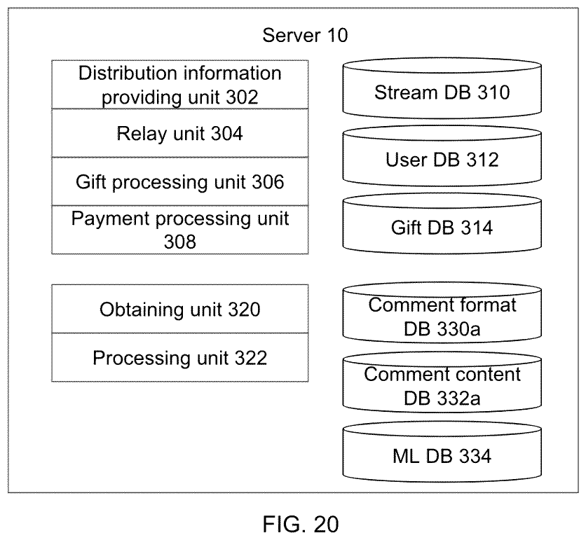

FIG. 20 shows a block diagram illustrating functions and configuration of the server 10 of FIG. 1 according to some embodiments of the present disclosure. The server 10 includes a distribution information providing unit 302, a relay unit 304, a gift processing unit 306, a payment processing unit 308, a stream DB 310, a user DB 312, a gift DB 314, an obtaining unit 320, a processing unit 322, a comment format DB 330a, a comment content DB 332a, and a ML DB 334.

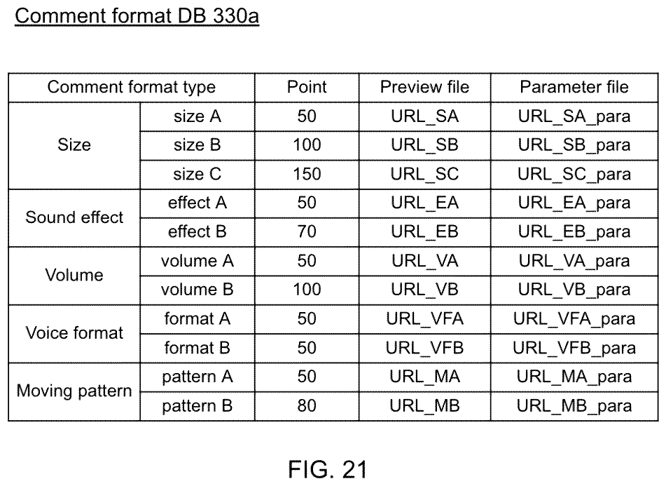

FIG. 21 is a data structure diagram showing an example of the comment format DB 330a. The comment format DB 330a stores the comment format type, the point, the preview file, and the parameter file, in association with each other.

The comment format type stores various format types for expressing a comment, and each format type has multiple selections. For example, the format type “size” may have different size selections for expressing a comment. In some embodiments, size A<size B<size C. For example, the format type “sound effect” may have multiple sound effects that could be played when expressing the comment. The sound effect may be or may not be related to the content of the comment.

For example, the format type “volume” may have different volumes of expressing a comment. In some embodiments, expressing a comment could include speaking out the content of the comment. For example, the format type “voice format” may have different voice types of expressing a comment, such as a male voice, a female voice, a robotic voice or an animated voice. For example, the format type “moving pattern” may have different patterns of moving the comment when expressing the comment. Different patterns may have different directions, different speeds, and/or different trajectories of moving the comment.

The point stores the amount of points a user (such as a viewer) needs to spend if he/she chooses a specific format type of expressing his/her comment. For example, if a user wants to express a comment in size A, 50 points would be cost from the user. For example, if a user wants a comment to be spoken in volume B, 100 points would be cost from the user.

The preview file stores URLs of preview files, each preview file corresponding to a specific format type of expressing the comment. In some embodiments, a preview file corresponding to “size” or “moving pattern” may have the format of image or video. In some embodiments, a preview file corresponding to “sound effect”, “volume”, or “voice format” may have the format of audio.

The parameter file stores URLs of parameter setting files, each parameter setting file corresponding to a specific format type of expressing the comment. For example, the parameter setting file URL_SA_para includes parameters needed to express (or render) the comment in size A. For example, the parameter setting file URL_MB_para includes parameters needed to express (or render) the comment according to the moving pattern B.

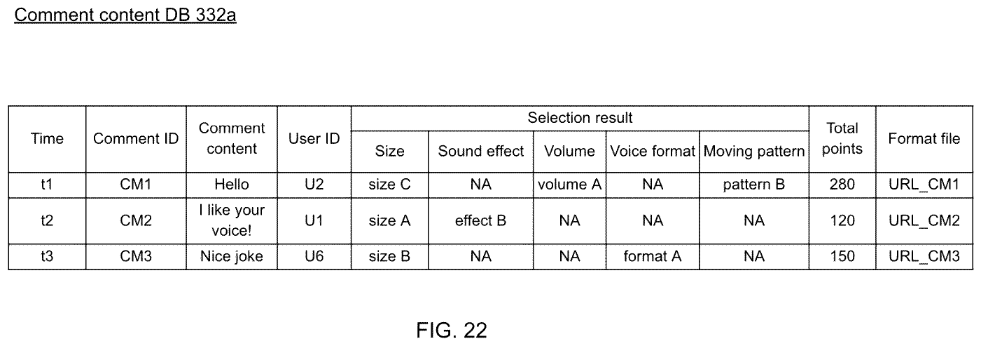

FIG. 22 is a data structure diagram showing an example of the comment content DB 332a. The comment content DB 332a stores the time, the comment ID, the comment content, the user ID, the selection result, the total point, and the format file, in association with each other.

The time identifies the timing or time span of receiving a comment. The comment ID is configured to identify each comment. The comment content stores the content of the comment. The user ID identifies the user from whom the comment is received.

The selection result stores the result of format type selection, which is selected by the user and is with respect to the comment. For example, user U2 selects [size C+volume A+moving pattern B] to express the comment CM1. For example, user U1 selects [size A+sound effect B] to express the comment CM2. The selection result is associated with the size, the sound effect, the volume, the voice format, and/or the moving pattern of expressing the comment.

The total point is the amount of points the user needs to spend in response to the selection result. The selection result is associated with the amount of points to be spent by the viewer.

In this embodiment, the total point is the sum of each point amount corresponding to each selected format type. For example, for expressing the comment CM1, user U2 needs to spend 280 points, which is the sum of 150 points (size C), 50 points (volume A), and 80 points (moving pattern B). For example, for expressing the comment CM2, user U1 needs to spend 120 points, which is the sum of 50 points (size A) and 70 points (sound effect B). In other embodiments, different calculations for the total points could be applied.

The format file stores URLs of format files. Each format file contains the data, codes or instructions that indicates how a comment would be expressed in a stream room. In some embodiments, the processing unit 322 (or the distribution information providing unit 302, or the relay unit 304) refers to the format file of a comment to express the comment in the stream room.

In some embodiments, the data in the comment content DB 332a could be obtained or stored by the obtaining unit 320. The total points could be calculated by the processing unit 322.

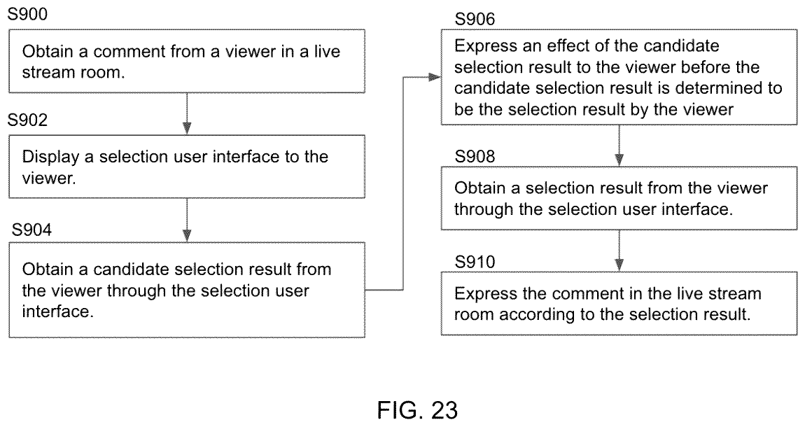

FIG. 23 shows an exemplary flow according to some embodiments of the present disclosure.

At step S900, the obtaining unit 320 obtains a comment from a viewer in a live stream room. The viewer may input the comment in the comment input area through a user terminal of the viewer.

At step S902, the processing unit 322 displays a selection user interface on the user terminal of the viewer. The selection user interface includes various format types that the viewer can choose to express the comment. The point amount corresponding to each format type may also be shown in the selection user interface.

At step S904, the obtaining unit 320 obtains a candidate selection result from the viewer through the selection user interface. For example, the viewer may click on one or more format types on the selection user interface. The candidate selection result could be a combination of format types before the combination of format types is determined to be the final selection result.

At step S906, the processing unit 322 expresses an effect (or preview effect) of the candidate selection result on the user terminal to the viewer, before the candidate selection result is determined to be the selection result by the viewer. For example, the candidate selection result may include format types [size A, volume A]. The processing unit 322 refers to the comment format DB 330a, to access the corresponding preview files (by URL_SA and URL_VA), and to display the preview effect by the preview files.

In some embodiments, the preview effect of one format type will be shown right after the viewer selects the format type. In some embodiments, the preview effect of a format type chosen later will be superimposed on the preview effect of a format type chosen previously.

At step S908, the obtaining unit 320 obtains a selection result (or final selection result) from the viewer through the selection user interface. The final selection result corresponds to the latest candidate selection result. The processing unit 322 may refer to the comment format DB 330a to access the corresponding parameter file(s), and to set the corresponding format file(s) in the comment content DB 332a according to the parameter file(s).

For example, refer to FIG. 22, user U1 selects [size A, sound effect B] as the selection result to express the comment CM2. The processing unit 322 accesses the corresponding parameter files through URL_SA_para and URL_EB_para in the comment format DB 330a, and sets the format file in URL_CM2 according to the two parameter files.

At step S910, the processing unit 322 expresses the comment in the live stream room according to the selection result. That is, the processing unit 322 expresses the comment according to the format file that has been set according to the parameter files determined by the selection result.

In this embodiment, the comment form the viewer is not displayed in the live stream room until the format selection result is determined by the viewer.

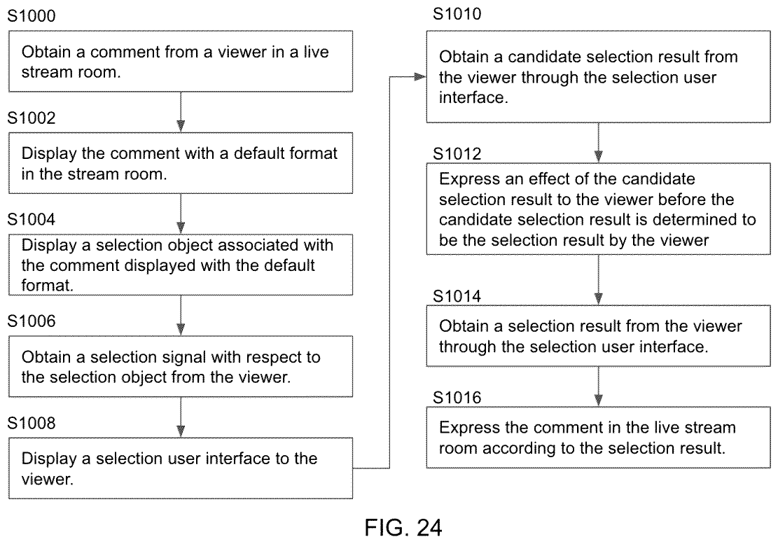

FIG. 24 shows an exemplary flow according to some embodiments of the present disclosure.

At step S1000, the obtaining unit 320 obtains a comment from a viewer in a live stream room. The viewer may input the comment in the comment input area through a user terminal of the viewer.

At step S1002, the processing unit 322 displays the comment with a default format in the stream room.

At step S1004, the processing unit 322 displays a selection object associated with the comment displayed with the default format. The selection object could only be displayed to the user terminal of the viewer who sent the comment.

At step S1006, the obtaining unit 320 obtains a selection signal with respect to the selection object from the viewer. That is, the viewer selected or clicked the selection object.

Steps S1008, S1010, S1012, S1014 and S1016 are the same or similar to steps S902, S904, S906, S908 and S910, respectively.

In this embodiment, the comment is firstly shown with a default format in the live stream room, and is re-expressed according to the selection result determined by the viewer in a later stage. The mechanism can re-emphasize a formerly sent comment to get the streamer's attention.

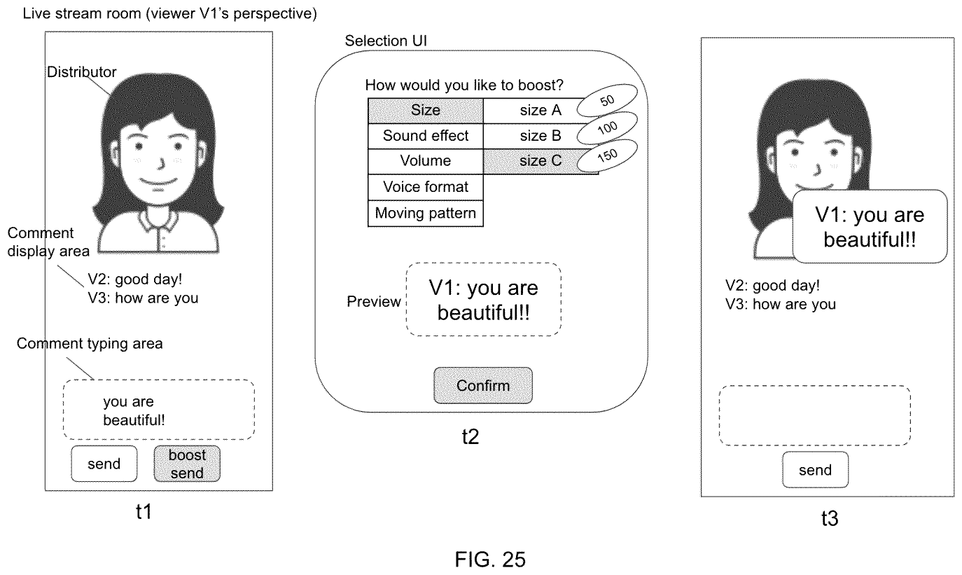

FIG. 25 shows an example of a live stream room according to some embodiments of the present disclosure. The user interface is from the perspective of viewer V1. The boost or emphasis of the comment is done during (or at the timing of) input of the comment.

At timing t1, viewer V1 types the comment in the comment typing area. Viewer V1 selects the “boost send” button to emphasize the comment.

At timing t2, a format selection user interface (UI) is displayed for the viewer to choose how to emphasize the comment. The UI shows the main format types, the selections of the selected main format type, the corresponding points, the preview area, and a confirm button. In this embodiment, viewer V1 selects [size] and then selects [size C], the preview area shows the comment with the effect of [size C] (which is a candidate selection result). Viewer V1 then selects “confirm” to confirm the selection result. In some embodiments, the format selection UI is displayed by the processing unit 322 by referring to the comment format DB 330a.

At timing t3, viewer V1's comment with the effect of [size C] is displayed in the stream room. The display could be done by the processing unit 322, for example, by referring to the comment content DB 332a. In some embodiments, the processing unit 322 causes the viewer to spend an amount of points corresponding to the selection result on the streaming platform. For example, the processing unit 322 may refer to the comment content DB 332a for the total points of expressing a comment, and then deduct the amount of points from the viewer in the user DB 312.

In some embodiments, the processing unit 322 may cooperate with the distribution information providing unit 302 or the relay unit 304 to express the comment.

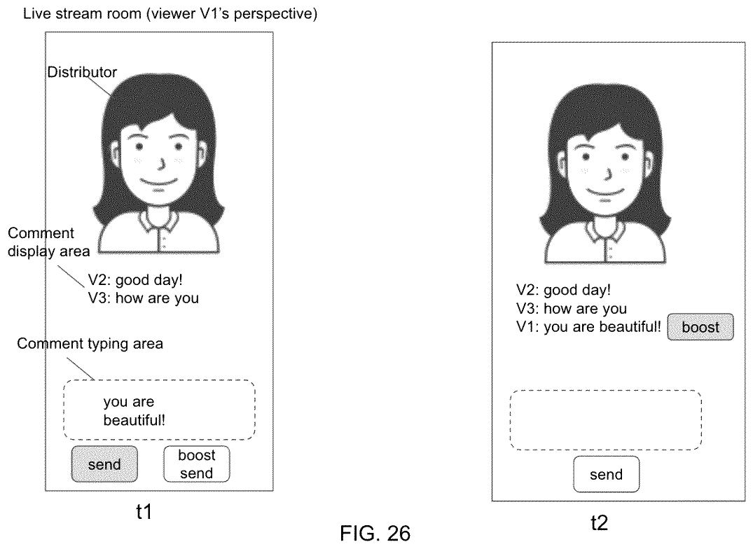

FIG. 26 shows an example of a live stream room according to some embodiments of the present disclosure. The user interface is from the perspective of viewer V1. The boost or emphasis of the comment is done after input of the comment.

At timing t1, viewer V1 types the comment in the comment typing area. Viewer V1 selects the “send” button to send out the comment.

At timing t2, the comment from viewer V1 is shown on the comment display area in the stream room, with a default format. A button “boost” associated with the comment is shown. In some embodiments, the boost button associated with a comment from viewer V1 is only visible to viewer V1. Viewer V1 then selects the “boost” button to emphasize the comment. Subsequently, the format selection UI is shown, which is similar to the UI in FIG. 25. The viewer may then choose how to emphasize the comment. Once the selection result is determined, the comment would be re-expressed according to the selected format in the stream room. The previous comment with the default format may or may not be maintained in the comment display area.

In some embodiments, for comments already sent, only the comments that have been sent within a predetermined time length (from a current timing) can be boosted. For example, the processing unit 322 may refer to the comment content DB 332a to check the timing of each comment, and only display the boost button associated with the comments sent within the predetermined time length. That can motivate the viewer to use the boost function in a timely manner, and can improve the revenue of the streaming platform.

In some embodiments, the comment format DB 330a can be implemented on the user terminal side, instead of the server side. For example, the data of the comment format DB 330a can be sent as a code or config data from the server to the user terminal. When the comment format DB 330a is implemented on the user terminal side, the preview process can be done by a processing unit within the user terminal, which can be faster and can save communication resources between the user terminal and the server. Once the user enters the comment in the comment typing area and determines the format selection result, the user terminal may transmit the comment content along with the corresponding expression parameters to the server. The server may then distribute the comment with the selected format(s) to the stream room, such that the emphasized comment can be seen by all users in the stream room.

In some embodiments, a cache memory in the user terminal or the server could be used to store the past comments sent by the viewer. The life time of the stored comment could be set as the predetermined time length during which the comment is possible to be emphasized or boosted.

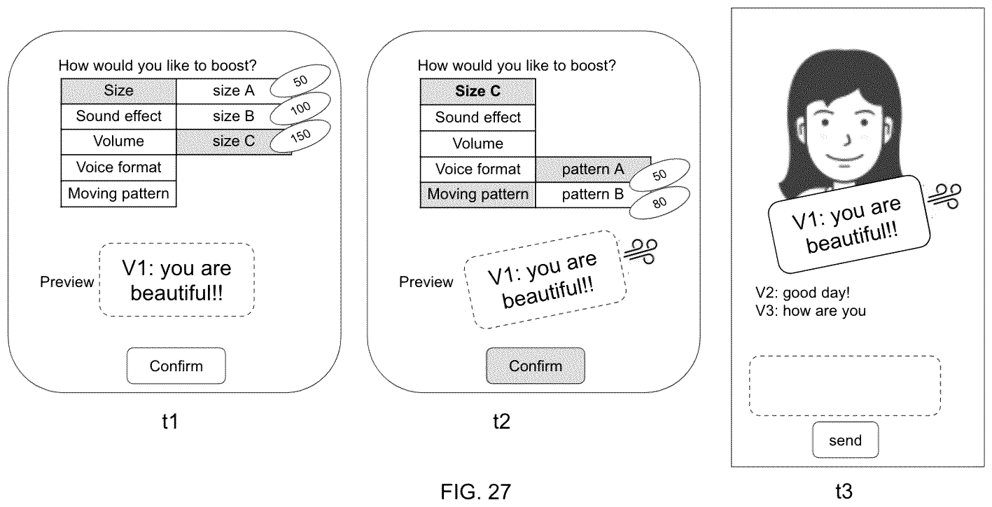

FIG. 27 shows an example of a live stream room according to some embodiments of the present disclosure. The user interface is from the perspective of viewer V1.

At timing t1, viewer V1 activates the boost function for a comment, and the format selection UI is shown. Viewer V1 selects “Size” and “size C”. The preview area displays the comment with size C.

At timing t2, viewer V1 further selects “Moving pattern” and “pattern A”. The preview area displays the effect of “moving pattern A” superimposed on the effect of “size C”. Viewer V1 then selects “confirm” to determine the selection result.

In some embodiments, the processing unit 322 may access the comment content in the comment content DB 332a, and may access the parameter files and the preview files, of multiple format types, in the comment format DB 330a, to display the preview of superimposed effects.

At timing t3, the comment from viewer V1 is shown in the stream room with the effect of “size C” and the effect of “moving pattern A”. In some embodiments, the comment will also be shown with the default format in the comment display area.

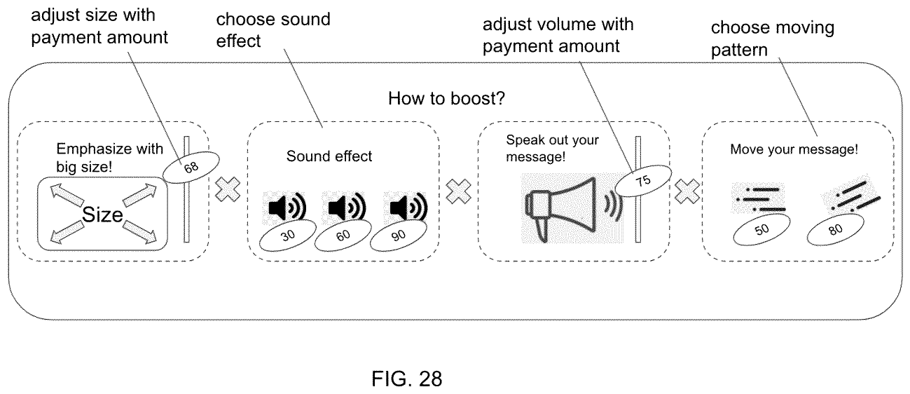

FIG. 28 shows an example of the format selection UI according to some embodiments of the present disclosure. The UI is shown once the viewer selects to initiate the boost function for a comment.

For each format type, the preview (or pre-listen) and the adjustment/selection object is shown separately. The viewer can scroll the scrolling bar of the “size format” to adjust and see the size change, along with the corresponding point amount. The viewer can choose different sound effects to listen to. The viewer can scroll the scrolling bar of the “volume format” to adjust the volume of speaking out the message. The viewer can choose different moving patterns according to the images (or animated images, or thumbnail videos). Some or all of the chosen effects may be superimposed or combined to determine the selection result of the format. The processing unit 322 will display the comment in the stream room according to the selection result.

In some embodiments, the format type to emphasize a comment could include pinning or fixing the comment onto a position of the stream room for a period of time. Pinning or fixing means that the comment will not be replaced (or washed away) by subsequent comments.

In some embodiments, the format type to express a comment may include female speaking voice or male speaking voice. For example, the processing unit may utilize the ML DB 334 to speak out the comment content in the corresponding voice. In some embodiments, the processing unit may utilize an AI model in the ML DB 334 to detect the mood in the comment content, and to speak out the comment content in the corresponding intonation. In some embodiments, when a sound effect is chosen to express the comment, the processing unit may utilize an AI model in the ML DB 334 to detect the mood in the comment content, and to adjust the sound effect (for example, volume, frequency or pitch) according to the mood of the comment content.

In some embodiments, the voice to speak out the comment could be a character's voice (or an animated voice) from a well known game or animation. In some embodiments, the streaming platform may cooperate with or may acquire the authorization of a famous IP. The voice may then be used to generate a voice/sound gift used in an event (or campaign) on the streaming platform.

In some embodiments, the format type to express a comment may include speaking out or displaying the comment in different languages. For example, the processing unit may utilize an AI model in the ML DB 334 to translate the comment content, and to speak or to display the translated content in the stream room.

Some embodiments of the present disclosure enable the viewer to express comments in a manner that can better catch the attention of the distributor. For example, when the distributor is live streaming a game play, the distributor may not be able to see the viewers' comments in the stream room. The sound effect or the speaking feature may help convey the comment to the distributor.

Notification on a streaming platform is an important feature that motivates or reminds the viewers to engage in streams. Therefore, it is desirable for a platform to have an efficient and optimal notification feature.

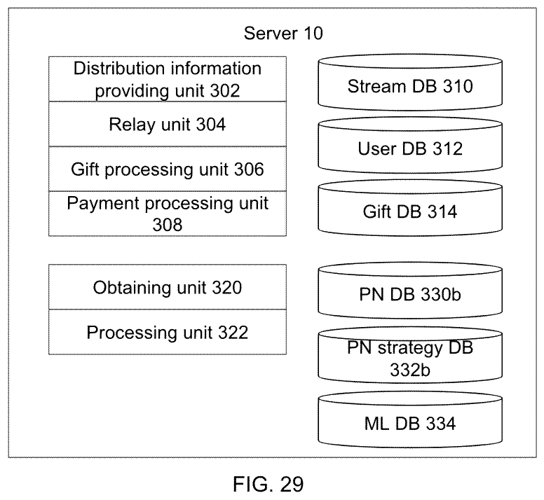

FIG. 29 shows an exemplary block diagram illustrating functions and configuration of the server 10 of FIG. 1 according to some embodiments of the present disclosure. The server 10 includes a distribution information providing unit 302, a relay unit 304, a gift processing unit 306, a payment processing unit 308, a stream DB 310, a user DB 312, a gift DB 314, an obtaining unit 320, a processing unit 322, a PN (push notification) DB 330b, a PN strategy DB 332b, and a ML DB 334.

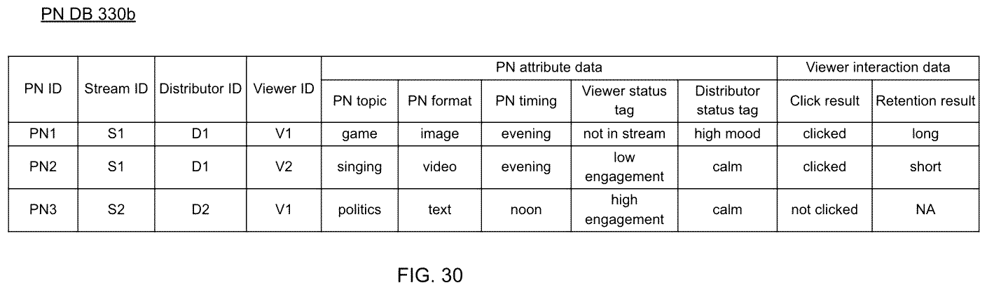

FIG. 30 is a data structure diagram showing an example of the PN DB 330b. The PN DB 330b stores the PN ID, the stream ID, the distributor ID, the viewer ID, the PN attribute data, and the viewer interaction data, in association with each other. The PN DB 330b stores values/contents of PN attributes and the interaction results of the viewers who receive those notifications.

Each PN ID identifies a push notification. The stream ID identifies the stream about which the PN notifies. The distributor ID identifies the distributor of the stream about which the PN notifies. The viewer ID identifies the viewer to whom the PN is sent to. The PN attribute data includes attributes of the notification, such as PN topic, PN format, PN timing, viewer status tag, and distributor status tag. The PN topic indicates the stream topic mentioned in the notification, which could be the real time detected topic of the stream. The PN format indicates the format with which the notification is presented to the viewer. The PN timing indicates the timing (or time span) the PN is sent to the viewer. The viewer status tag indicates a status of the viewer when (or right before) receiving the PN. The distributor status tag indicates a status of the distributor in the stream when (or right before) the PN is sent.

The viewer interaction data includes interaction results of the viewer with respect to the notification, such as click result and retention result.

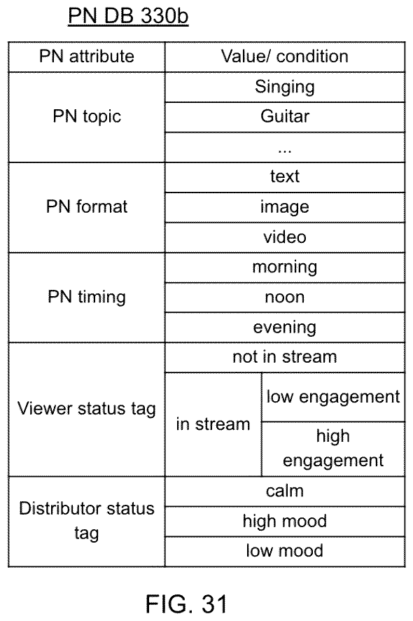

FIG. 31 is a data structure diagram showing an example of the PN DB 330b. Each PN attribute and examples of its possible values (or conditions/classifications/types/contents) are specified. The values could be recorded in the PN DB 330b as shown in FIG. 30.

For the PN topic, the topic detected from the stream corresponding to the notification could be recorded. The topic is detected at the timing (or right before) the notification is transmitted. The topic could be detected or determined by the processing unit 322 and/or the ML DB 334. For example, the ML DB 334 may include image detection model, video detection model, or audio detection model which could be used to analyze the stream's topic.

For the PN format, the notification could possess the form of text, image, or video. In some embodiments, the video format and/or the image format could include text.

For the PN timing, classifications such as morning, noon, and evening could be utilized. In some embodiments, exact timing of the PN transmission could be recorded also. In some embodiments, whether it's working time or non-working time for the notified viewer (which could be determined by the user profile or behavior history, for example) could also be recorded.

For the viewer status tag, whether or not the notified viewer is in a live stream room when receiving the PN could be recorded. If the viewer is in a live stream room, the engagement level (or real time engagement level when receiving the PN) of the viewer could also be recorded. The engagement level could be analyzed by the processing unit 322 and/or the ML DB 334 utilizing the viewer's behavior, such as commenting or gifting, in the stream room. Whether or not the viewer is in a live stream room, and whether or not the viewer is engaged in a live stream room, may affect the response of the viewer with respect to a newly received PN.

For the distributor status tag, a mood (or engagement level) of the distributor could be recorded. For example, the processing unit 322 may utilize the ML DB 334 to analyze the real time image data/video data/audio data of the stream room to determine the mood of the distributor. The data could be used to determine the impact of the distributor status on each viewer who clicked the PN.

The PN attribute data could also include other attributes such as PN content length or PN mood. The value of the PN content length could be short or long according to the content length of the PN. A mood of the PN could also be classified/analyzed to be calm, high mood, or low mood. The mood classification could be made by the processing unit 322 utilizing the ML DB 334. For example, the mood of a PN could be obtained by inputting the PN content into the ML DB 334.

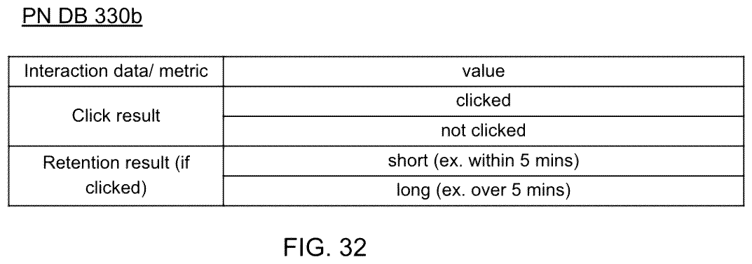

FIG. 32 is a data structure diagram showing an example of the PN DB 330b. Each interaction data (or metric) and examples of its possible values (or conditions/classifications/types/contents) are specified. The values could be recorded in the PN DB 330b as shown in FIG. 30.

The click result indicates or records whether or not the viewer clicks (or selects) the PN. If the viewer clicks in the PN, the retention result indicates or records how long the viewer stays in the stream corresponding to the PN. In some embodiments, the retention result could store the exact time length of the viewer staying in the stream.

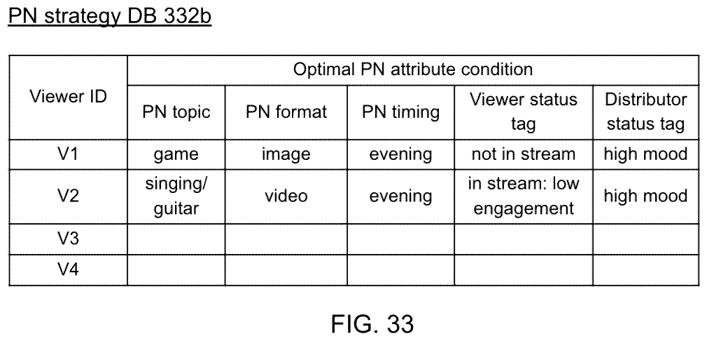

FIG. 33 is a data structure diagram showing an example of the PN strategy DB 332b. The PN strategy DB 332b stores the viewer ID and the optimal PN attribute condition (or notification attribute condition), in association with each other. The optimal PN attribute condition stores the optimal conditions for various PN attributes with respect to each viewer. The term “optimal” means the condition(s) may result in the corresponding viewer tending to click in the notification and/or tending to stay longer in the stream room after clicking the notification.

For example, for viewer V1, a notification with the conditions [PN topic=game, PN format=image, PN timing=evening, viewer status tag=not in stream] has a better chance of being clicked/selected. For example, for viewer V1, a notification with the condition [distributor status tag=high mood] has a better chance to retain the viewer longer in the stream room after being clicked/selected.

The optimal conditions in the PN strategy DB 332b could be calculated by the processing unit 322 and/or the ML DB 334, according to the data in the PN DB 330b. For example, the chance of each condition of each PN attribute resulting in a successful click with respect to each viewer can be calculated. The optimal condition for each PN attribute can be determined accordingly.

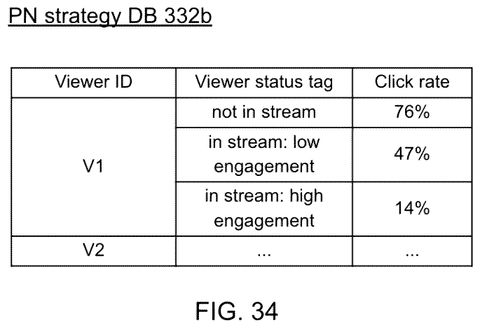

FIG. 34 is a data structure diagram showing an example of the PN strategy DB 332b. The click rate for each condition of the PN attribute [viewer status tag] is calculated for each viewer. The calculation could be done with various known statistical methods based on the PN DB 330b. As shown, when viewer V1 is not in any live stream, the notification has the highest probability of being clicked by viewer V1 (click rate 76%). When viewer V1 is in a live stream, then it is more likely for viewer V1 to click the notification when viewer V1 is less engaged in the stream (click rate 47%). Viewer V1 may tend to ignore the notification if viewer V1 is highly engaged in a live stream (click rate 14%).

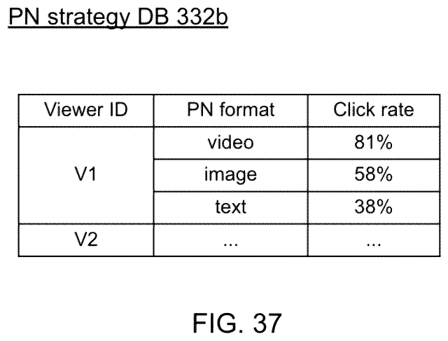

FIG. 37 is a data structure diagram showing an example of the PN strategy DB 332b. The click rate for each condition of the PN attribute [PN format] is calculated for each viewer. The calculation could be done with various known statistical methods based on the PN DB 330b. As shown, a notification with the video format has an 81% chance of being clicked by viewer V1. A notification with the image format has a 58% chance of being clicked by viewer V1. A notification with the text format has a 38% chance of being clicked by viewer V1.

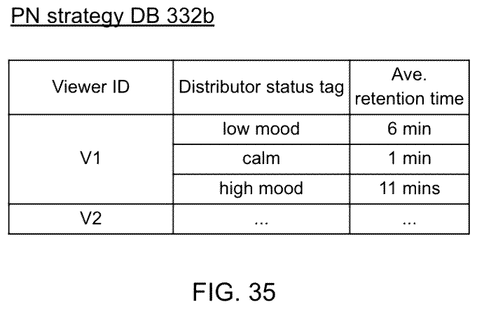

FIG. 35 is a data structure diagram showing an example of the PN strategy DB 332b. The average retention time (after clicking into the notification and joining a stream) for each condition of the PN attribute [distributor status tag] is calculated for each viewer. The calculation could be done with various known statistical methods based on the PN DB 330b. As shown, if the distributor is in a high mood when viewer V1 clicks the notification and joins the stream, the average retention time is the longest (11 mins). If the distributor is in a low mood when viewer V1 clicks the notification and joins the stream, the average retention time is 6 mins. A calm mood of the distributor results in the shortest retention time for viewer V1 (1 min).

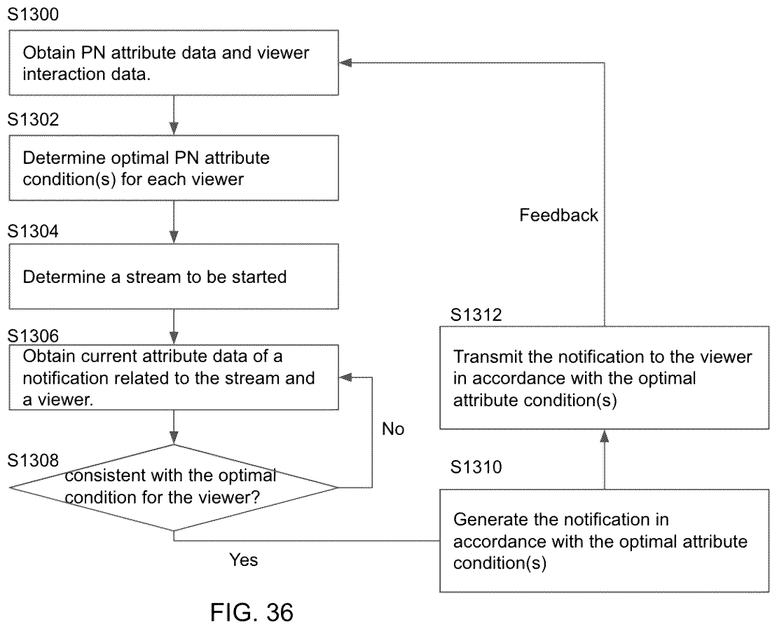

FIG. 36 shows an exemplary flow according to some embodiments of the present disclosure.

At step S1300, the obtaining unit 320 obtains the PN attribute data and the viewer interaction data. According to different embodiments, those data could be obtained from inside server 10 or from a monitoring unit/service outside server 10.

At step S1302, the processing unit 322 and/or the ML DB 334 determines the optimal PN attribute condition(s) for each viewer. The optimal PN attribute conditions could include, for example, the optimal PN topic, the optimal PN format, the optimal PN timing, the optimal viewer status tag, and/or the optimal distributor status tag, for each viewer. The determination (or calculation) could be made according to the PN DB 330b and could be stored into the PN strategy DB 332b.

At step S1304, a stream (or live stream) is started by a distributor.

At step S1306, the obtaining unit 320 obtains current attribute data of a notification (or candidate notification, or notification under preparation) related to the stream and a viewer. The candidate notification could be associated with the stream and the viewer, or could be associated with the viewer and the distributor of the stream. For example, the viewer could be a follower of the distributor. For example, the stream platform determines the viewer to be a legitimate (or qualified) receiver of a notification about the stream (or the distributor), based on certain matching algorithms (such as similarity matching or topic matching). The attribute data could include, for example, the stream's topic (or real time topic), the PN format, the PN timing, the viewer status tag and/or the distributor status tag.

At step S1308, the processing unit 322 determines whether or not the current attribute data of the candidate notification is consistent with (or meets) one or more optimal notification conditions for the viewer. The definition of “meeting the optimal condition(s)” could be defined in various ways according to the actual practice. If yes, the flow goes to step S1310. If not, the flow goes back to step S1306 to keep monitoring the attribute data (or keep obtaining new attribute data).

At step S1310, the processing unit 322 generates the notification in accordance with the optimal attribute condition(s).

At step S1312, the processing unit 322 transmits the notification to the viewer in accordance with the optimal attribute condition(s). The flow then goes back to step S1300.

For example, at step S1302, the optimal PN attribute conditions for viewer V1 are determined to be [PN topic=game, PN format=image, PN timing=evening, viewer status tag=not in stream, distributor status tag=high mood]. The optimal PN attribute conditions for viewer V2 are determined to be [PN topic=singing/guitar, PN format=video, PN timing=evening, viewer status tag=in stream & low engagement, distributor status tag=high mood]. At step S1304, a stream S1 of distributor D1 followed by both viewer V1 and viewer V2 is started.

At timing (or time span) t1, at step S1306, the topic of the stream is detected to be “game”, and the distributor status tag is detected to be “high mood”. At step S1308, it is determined that enough optimal conditions are met for viewer V1 (but not for viewer V2). At step S1310, a notification is generated to have the text “D1 is playing game!” combined with an image clipped from the stream room. At step S1312, the notification is transmitted to viewer V1, such that the image and the text are displayed to viewer V1.

At timing (or time span) t2, at step S1306, the topic of the stream is detected to be “guitar” (the stream topic has been changed from “game” to “guitar”), and viewer V2's viewer status tag is detected to be “in stream & low engagement”. At step S1308, it is determined that enough optimal conditions are met for viewer V2. At step S1310, a notification is generated to have the text “D1 is playing guitar!” combined with a video clipped from the stream room. At step S1312, the notification is transmitted to viewer V2, such that the video and the text are displayed to viewer V2.

As described above, with respect to the same stream, the content (such as text content), the format, and/or the timing of the notifications to different viewers could be customized. The transmission timing could depend on the distributor's status and/or each viewer's status.

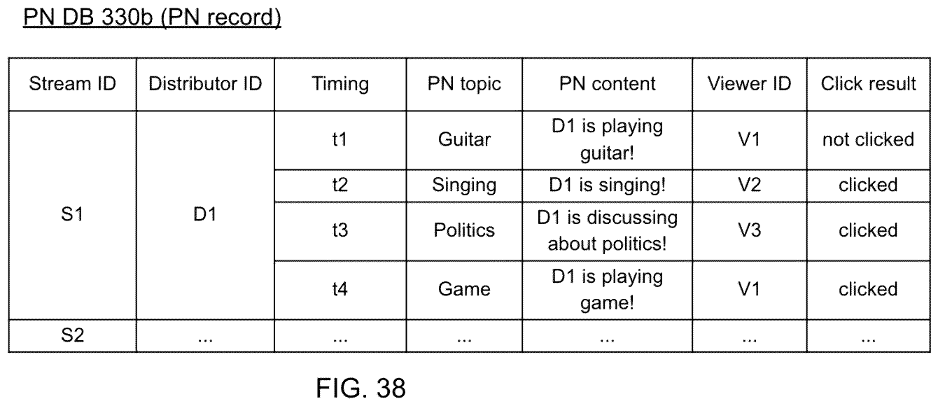

FIG. 38 is a data structure diagram showing an example of the PN DB 330b. The PN DB 330b stores the stream ID, the distributor ID, the timing of the notification, the PN topic, the PN content, the viewer ID (receiver), and click result, in association with each other.

The PN topic is the detected stream topic at the notification timing. The PN content is the content (such as text) displayed to the viewer in the notification, which could be generated according to the PN topic. The click result indicates whether the notification is clicked or selected by the viewer.

In this embodiment, the optimal PN topic(s) for viewer V1 include “guitar” and “game”, and the optimal PN topic(s) for viewer V2 include “singing”. Therefore, when the topic “guitar” is detected at timing t1, a notification with the content “D1 is playing guitar!” is sent to viewer V1. When the topic “singing” is detected at timing t2, a notification with the content “D1 is singing!” is sent to viewer V2.

In some embodiments, the processing unit 322 checks the click result to determine if an additional notification should be sent to a viewer who already received a former notification (with respect to the same stream). For example, the notification at timing t1 sent to viewer V1 is not clicked. At timing t4, the topic “game” is detected, which also meets the optimal PN topic condition for viewer V1, therefore an additional notification with the content “D1 is playing game!” is sent to viewer V1. In some embodiments, when the processing unit 322 determines (1) a former notification was not successful and (2) a newly obtained attribute data (which is different from the former one) meets the optimal PN condition for the viewer, the processing unit 322 may send a notification again.

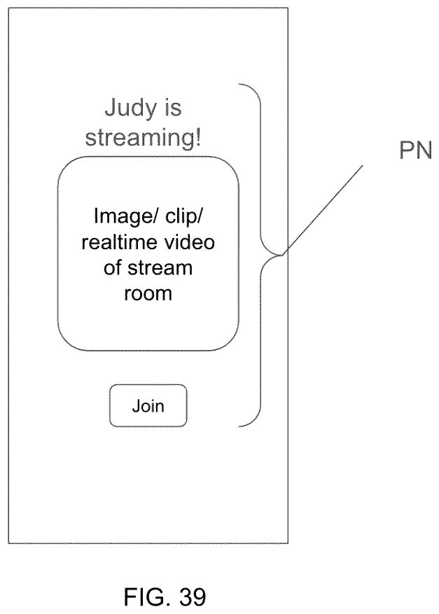

FIG. 39 shows an exemplary notification according to some embodiments of the present disclosure. The notification includes a text part “Judy is streaming”. The notification could also display an image clipped from the stream room, a video clip from the stream room, or a real time display (or preview) of the stream room. The receiver could click the “join” button to join the stream room. In some embodiments, the clipped image or the clipped video could correspond to the optimal PN topic of the viewer receiving the notification. For example, when the processing unit 322 detects the stream topic to meet the optimal PN topic of a viewer, the processing unit 322 may utilize the ML DB 334 to extract an image or a video clip that's determined (by the ML DB 334) to best reflect the topic, and to send that image or video clip to the viewer as part of the notification.

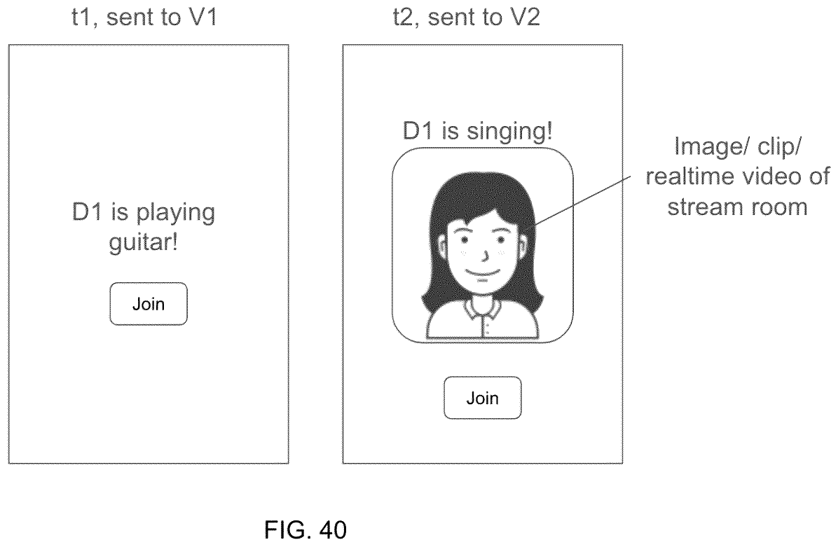

FIG. 40 shows exemplary notifications according to some embodiments of the present disclosure. At timing t1, the stream of distributor D1 is detected to have the topic “guitar”, which meets the optimal condition for viewer V1. Therefore, the notification is sent to viewer V1 in text form, which has a higher click rate for viewer V1. At timing t2, the same stream of distributor D1 is detected to have the topic “singing”, which meets the optimal condition for viewer V2. Therefore, the notification is sent to viewer V2 in image/video form, which has a higher click rate for viewer V2.

Some embodiments of the present disclosure provide customized push notifications for each viewer, to improve the click rate and even the retention time in the stream room.

The present techniques will be better understood with reference to the following enumerated embodiments:
A1. A method for live streaming, executed by a server, including:
obtaining a comment from a viewer in a live stream room;
displaying a selection user interface to the viewer;
obtaining a selection result from the viewer through the selection user interface; and expressing the comment in the live stream room according to the selection result.
A2. The method according to embodiment A1, wherein the selection result is associated with an amount of points to be spent by the viewer.
A3. The method according to embodiment A1, wherein the selection result is associated with a volume of expressing the comment.
A4. The method according to embodiment A1, wherein the selection result is associated with a sound effect of expressing the comment.
A5. The method according to embodiment A1, wherein the selection result is associated with a moving pattern of expressing the comment.
A6. The method according to embodiment A1, wherein the selection result is associated with a size of expressing the comment.
A7. The method according to embodiment A1, wherein the selection result is associated with a language of expressing the comment.
A8. The method according to embodiment A1, wherein the expressing the comment includes speaking out a content of the comment in the live stream room.
A9. The method according to embodiment A1, further including:
obtaining a candidate selection result from the viewer through the selection user interface, the candidate selection result corresponding to the selection result; and
expressing an effect of the candidate selection result to the viewer before the candidate selection result is determined to be the selection result by the viewer.
A10. The method according to embodiment A1, wherein the comment is not displayed in the stream room until the expressing the comment in the live stream room according to the selection result.
A11. The method according to embodiment A1, further including:
displaying the comment with a default format in the stream room;
displaying a selection object associated with the comment displayed with the default format; and
obtaining a selection signal with respect to the selection object from the viewer,
wherein the displaying the selection user interface to the viewer is in response to the obtaining the selection signal.
A12. The method according to embodiment A1, further including:
causing the viewer to spend an amount of points corresponding to the selection result on a streaming platform providing the live stream room.
A13. A system for live streaming, including one or a plurality of processors, wherein the one or plurality of processors execute a machine-readable instruction to perform:
obtaining a comment from a viewer in a live stream room;
displaying a selection user interface to the viewer;
obtaining a selection result from the viewer through the selection user interface; and
expressing the comment in the live stream room according to the selection result.
A14. A non-transitory computer-readable medium including a program for live streaming, wherein the program causes one or a plurality of computers to execute:
obtaining a comment from a viewer in a live stream room;
displaying a selection user interface to the viewer;
obtaining a selection result from the viewer through the selection user interface; and
expressing the comment in the live stream room according to the selection result.
B1. A method for notification, executed by a server, including:
transmitting a first notification to a first viewer in accordance with a first condition, the first notification being related to a stream; and
transmitting a second notification to a second viewer in accordance with a second condition, the second notification being related to the stream,
wherein the first condition is different from the second condition.
B2. The method according to embodiment B1, wherein the first condition and the second condition include different topics of the stream, and a timing of transmitting the first notification to the first viewer is different from a timing of transmitting the second notification to the second viewer.
B3. The method according to embodiment B1, wherein the first condition and the second condition include different notification formats, and the different notification formats include text format, image format, or video format.
B4. The method according to embodiment B1, wherein the first condition is related to a tag indicating the first viewer being in a live stream room or not.
B5. The method according to embodiment B1, wherein the first condition is related to the first viewer's real time engagement level in a live stream room.
B6. The method according to embodiment B1, wherein the stream is live stream, and the first condition is related to real time mood level of a distributor providing the stream.
B7. The method according to embodiment B1, wherein the stream is live stream at a first timing of the transmitting the first notification to the first viewer and at a second timing of the transmitting the second notification to the second viewer, and the first timing is different from the second timing.
B8. The method according to embodiment B1, wherein the first condition is determined according to past attribute data of past notifications sent to the first viewer and past interaction data of the first viewer with respect to the past attribute data, wherein the past attribute data includes various conditions.
B9. The method according to embodiment B8, wherein the past interaction data includes a click rate with respect to the past notifications.
B10. The method according to embodiment B8, wherein the past interaction data includes a retention time with respect to streams corresponding to the past notifications.
B11. The method according to embodiment B8, further including:
determining a current attribute data of the first notification to be consistent with the first condition before the transmitting the first notification to the first viewer.
B12. A system for notification, including one or a plurality of processors, wherein the one or plurality of processors execute a machine-readable instruction to perform:
transmitting a first notification to a first viewer in accordance with a first condition, the first notification being related to a stream; and
transmitting a second notification to a second viewer in accordance with a second condition, the second notification being related to the stream, wherein the first condition is different from the second condition.
B13. A non-transitory computer-readable medium including a program for notification, wherein the program causes one or a plurality of computers to execute:
transmitting a first notification to a first viewer in accordance with a first condition, the first notification being related to a stream; and
transmitting a second notification to a second viewer in accordance with a second condition, the second notification being related to the stream,
wherein the first condition is different from the second condition.

What is claimed is:

1. A method for recommendation, executed by a server, comprising:
detecting a change of an interaction parameter in a live stream;
determining the change to have met a predetermined criterion; and
recommending the live stream to a user within a time period of the determining the change to have met the predetermined criterion.

2. The method according to claim 1, wherein the interaction parameter is related to a number of viewers in the live stream, a number of comments in the live stream, a number of emojis in the live stream, a number of gifts in the live stream, or a total value of gifts in the live stream.

3. The method according to claim 1, wherein the change is related to an increase rate change of the interaction parameter, and the determining the change to have met the predetermined criterion includes determining the change to have met a predetermined threshold.

4. The method according to claim 1, further comprising:
determining a topic in the live stream; and
determining the user to have input a content related to the topic on a platform providing the live stream.

5. The method according to claim 4, wherein the content was input by the user in another live stream different from the live stream.

6. The method according to claim 4, wherein the content was input by the user within a predetermined time span before or after the determining the topic in the live stream.

7. The method according to claim 1, wherein the recommending the live stream to the user includes sending a notification to the user.

8. The method according to claim 7, wherein the notification is sent to the user when the user is in another live stream.

9. A system for recommendation, comprising one or a plurality of processors, wherein the one or plurality of processors execute a machine-readable instruction to perform:
detecting a change of an interaction parameter in a live stream;
determining the change to have met a predetermined criterion; and
recommending the live stream to a user within a time period of the determining the change to have met the predetermined criterion.

10. A non-transitory computer-readable medium including a program for recommendation, wherein the program causes one or a plurality of computers to execute:
detecting a change of an interaction parameter in a live stream;
determining the change to have met a predetermined criterion; and
recommending the live stream to a user within a time period of the determining the change to have met the predetermined criterion.
